(19) United States
(12) Patent Application Publication
(10) Pub. No.: US 2024/0417653 A1
(43) Pub. Date: Dec. 19, 2024

(54) LAUNDRY DETERGENT ARTICLE

(71) Applicant: Church & Dwight Co., Inc., Princeton, NJ (US)

(72) Inventors: Thomas Johnson, Hightstown, NJ (US); Steven T. Adamy, Lawrenceville, NJ (US); Vaidehi Shah, Manalapa, NJ (US); Joan Gambogi, Hillsborough, NJ (US); Robert T. Zehr, Somerset, NJ (US); Olga Savtchouk, Princeton, NJ (US); Leilani Pechera, Kendall, NJ (US); Archana Gupta, Belle Mead, NJ (US); William D. Platt, Lumberton, NJ (US)

(21) Appl. No.: 18/742,481

(22) Filed: Jun. 13, 2024

Related U.S. Application Data
(60) Provisional application No. 63/472,633, filed on Jun. 13, 2023.
(60) Provisional application No. 63/610,812, filed on Dec. 15, 2023.

(51) Int. Cl. C11D 17/04; C11D 1/722; C11D 3/00

(52) U.S. Cl. CPC C11D 17/044; C11D 1/722; C11D 3/0052

(57) ABSTRACT

The present disclosure provides cleaning articles. The articles can be formed of two outer layers separated by an intermediate layer that can comprise one or more independent and separate compositions. The outer layers can be formed of a solid foam and can particularly be configured to allow access of the surrounding environment to the intermediate layer compositions. The outer layers can provide rapid infiltration of water to facilitate diffusion of the intermediate layer compositions through the outer layers, and dissolution of the outer layers and the intermediate layer(s).

### CROSS-REFERENCE TO RELATED APPLICATIONS

The present application claims priority to U.S. Provisional Patent Application No. 63/610,812, filed Dec. 15, 2023, and U.S. Provisional Patent Application No. 63/472,633, filed Jun. 13, 2023, the disclosures of which are incorporated herein by reference in their entireties.

### FIELD OF THE DISCLOSURE

The present disclosure relates to detergent formulations and articles for unit dose provision of the detergent formulations with improved dissolution properties, particularly for automatic laundry machines. The articles can comprise a detergent formulation that is contained within porous sheet materials, such as sheets formed of a water soluble material.

### BACKGROUND

The use of water soluble film carriers to deliver unit dosage amounts of laundry products is known, and detergents and bleaches have been sold in this form for many years. Known unit dose detergent articles can suffer from poor dissolution of the carrier material, and this can exacerbate poor dissolution properties of detergents retained by the carrier. This can result in wash cycles where a substantially undissolved carrier remains in the wash load or where residue is present due to detergents that were released from the article but not fully dissolved. There is still a desire and a need to provide laundry detergent compositions that are in unit dose forms. There is also a desire and need for unit does laundry compositions and articles that achieve improved solubility in laundry machines while maintaining the consumer expected efficacy of current liquid laundry detergents and sachets. Furthermore, there is a desire to visually queue the differentiated product types (i.e. sub brands and/or targeted benefits such as odor control, stain fighting, softening) in a way that still optimizes full dissolution during the wash.

### SUMMARY OF THE DISCLOSURE

The present disclosure relates to laundry detergent articles. A laundry detergent article as described herein can be provided as a unit dose article in that the article is intended to provide, as an individual unit, a sufficient quantity of detergent for carrying out laundering of a typical load in standard washing machines. The articles comprise a detergent included at least partially within a water soluble sheet material to provide the unit dose. More particularly, a unit dose laundry detergent article according to the present disclosure can be defined at least by two, outer sheets and at least one intermediate layer positioned between the two, outer sheets. An individual sheet can be specifically configured as a solid foam, water soluble material. The sheet material includes pores that provide for improved infiltration of water for diffusion of the detergent materials retained thereby through the sheet material and dissolution of the sheet material itself. An individual detergent material can form a part of an outer sheet and/or can be present in the at least one intermediate layer. Alternatively, or additionally, one or more detergent materials can be combined to form a detergent composition that is provided as the at least one intermediate layer. In some embodiments, a plurality of different detergent compositions can be deposited as multiple distinctive fillers that define a single intermediate layer or a plurality of intermediate layers. The distinctive fillers (i.e., the distinctive detergent compositions) can exhibit visually distinct colors, such as blue, green, pink, purple, white, or a combination thereof, and may indicate a cleaning function. The configuration of the disclosed laundry detergent article can provide multiple advantages, such as improving diffusion of the detergent and beneficially providing additive cleaning efficacy.

Compositions defining one or more intermediate layers or fillers can be specifically formulated to exhibit high solubility in water so that the detergent materials can quickly disperse in a wash water to provide the detergent function to articles being washed. Such compositions also can be provided in a form that imparts stability so that the compositions remain in a solid or semi-solid state and thus avoid running or seeping out of the boundaries defined by the outer sheets. This combination of high solubility and high stability can be difficult to achieve, and the present disclosure can relate to specific formulations that impart this combination of properties. In certain embodiments, this particularly can comprise formulations wherein a detergent composition is combined with a polymer additive to form a stable, foam structure.

In one or more embodiments, a cleaning article according to the present disclosure can comprise: a first outer layer that is porous and comprises a water soluble polymer; a second outer layer that is porous and comprises a water soluble polymer; and an intermediate layer arranged between the first outer layer and the second outer layer, the intermediate layer comprising at least a first segment and a second segment, the first segment being formed of a first composition having at least one cleaning component and the second segment being formed of a second composition having at least one cleaning component, the second composition being different from the first cleaning composition, the at least a first segment and a second segment being arranged one or both of longitudinally and laterally across the cleaning article. In further embodiments, the cleaning article can be defined in relation to one or more of the following statements, which can be combined in any number and/or order.

One or both of the first outer layer and the second outer layer can comprise a cleaning component.

One or both of the first outer layer and the second outer layer can be configured as a solid foam sheet.

One or both of the first outer layer and the second outer layer can be configured as fabric.

The first outer layer and the second outer layer each can be configured as a sheet with a porosity, measured as pore void volume divided by a total sheet volume, the porosity being about 10% to about 90%.

At least one of the first composition and the second composition can be configured as a foam comprising a water soluble polymer having a melting point in the range of about 40° C. to about 80° C. mixed with the at least one cleaning component.

The water soluble polymer can be a polyethylene glycol (PEG) polymer.

The PEG polymer can have a molecular weight of about 1,000 Da to about 300,000 Da.

The water soluble polymer can comprise about 10% to about 50% by weight of the foam structure.

At least one of the first cleaning composition and the second cleaning composition can be configured as a semi-solid.

The semi-solid can have a complex modulus (G*) at ambient temperature of no less than 5,000 Pa.

The semi-solid can be a paste.

The semi-solid can comprise about 10% by weight or greater of one or both of water soluble solids and water insoluble solids.

The semi-solid can comprise water soluble solids in an amount of about 30% to about 80% by weight based on the total weight of the cleaning composition.

The semi-solid can comprise an alkali metal salt.

The semi-solid can be anhydrous.

The semi-solid can comprise at least one base and at least one acid effective to react and form carbon dioxide gas when in contact with water.

The cleaning article can be substantially completely water soluble at a temperature of about 15° C. to about 30° C. in a time of about 0.5 minutes to about 10 minutes.

The at least one cleaning component can be selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).

The first composition and the second composition individually can comprise one of a cleaning composition, an odor elimination composition, a softening composition, a bleaching composition, an enzymatic composition, and a booster composition.

The first composition can have a first color and the second composition can have a second color that is visually distinct from the first color.

The first color of the first composition can correspond to a first cleaning function and the second color of the second composition can correspond to a second cleaning function that is different from the first cleaning function.

The at least a first segment and a second segment can be arranged as a colored pattern that is visible through one or both of the first outer layer and the second outer layer.

The colored pattern can be an alternating pattern of one or both of linear and curved strips.

One or both of the first outer layer and the second outer layer can have a transparency of about 5% to about 50%.

A brightness of each of the first color and the second color can be greater in a cross-sectional view of the cleaning article than when the intermediate layer is viewed through one or both of the first outer layer and the second outer layer.

At least one of the first color and the second color can be defined by one of the following: a blue color defined by L*a*b* values of about 64, about −14, and about −20, respectively; a green color defined by L*a*b* values of about 75, about −10, and about 8, respectively; a purple color defined by L*a*b* values of about 75, about 5, and about −7, respectively.

The first color can have a first set of L*a*b* values when measured at an edge of the cleaning article where the intermediate layer is unobstructed by the first outer layer or the second outer layer and can have a second, different set of L*a*b* values when measured through one of the first outer layer and the second outer layer.

The L* value of the first color can be greater when measured through one of the first outer layer and the second outer layer.

One or both of the a* value and the b* value can be less when measured through one of the first outer layer and the second outer layer.

The cleaning article can have a length measured along a longitudinal axis, a width measured across a lateral axis, and a thickness measured transverse to the longitudinal axis and the lateral axis, and one of the following can apply: the cleaning article can be configured with a ratio of length to width (L:W) of about 1:1 to about 10:1; the cleaning article can be configured with a ratio of length to thickness (L:T) of about 10:1 to about 200:1; and the first outer layer, the second outer layer, and the intermediate layer each can have individual thicknesses, and a ratio of the individual thickness of either of the first outer layer or the second outer layer to the individual thickness of the intermediate layer can be about 0.05:1 to about 2:1.

The first outer layer can have a first outer layer face with a first face area, the second outer layer can have a second outer layer face with a second face area, and a sum of the first face area and the second face area can be a total face surface area of the cleaning article; wherein the intermediate layer can define an edge along one or more sides of the cleaning article where the intermediate layer is not covered by the first outer layer or the second outer layer, the edge having a total edge surface area; and wherein the cleaning article can be configured with an Edge to Face Area Ratio (EFAR) defined as a ratio of the total edge surface area to the total face surface area, of less than 0.5.

The EFAR can be about 0.01 to about 0.5.

In one or more embodiment, the present disclose can comprise a method of preparing a cleaning article, the method comprising: combining a first composition having at least one cleaning component and a second composition having at least one cleaning component with a first outer layer and a second outer layer to form an intermediate layer between the first outer layer and the second outer layer; wherein the first composition defines a first segment of the intermediate layer, and the second composition defines a second segment of the intermediate layer; and wherein the combining is carried out so that the first segment and the second segment are arranged one or both of longitudinally and laterally across the cleaning article between the first outer layer and the second outer layer. The disclosure further encompasses a cleaning article prepared according to the method. In further embodiments, the cleaning article can be defined in relation to one or more of the following statements, which can be combined in any number and/or order.

The first outer layer and the second outer layer each can be porous and can comprise a water soluble polymer.

The cleaning article can be substantially completely water soluble at a temperature of about 15° C. to about 30° C. in a time of about 0.5 minutes to about 10 minutes.

The at least one cleaning component can be selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).

In one or more embodiments, a cleaning article according to the present disclosure can comprise: a detergent composition; and a water soluble polymer having a melting point in the range of about 40° C. to about 80° C.; wherein the detergent composition and the water soluble polymer are intermixed and define a foam structure. In further embodiments, the cleaning article can be defined in relation to one or more of the following statements, which can be combined in any number and/or order. The foam structure can be substantially non-flowing at a temperature of less than 40° C. and at ambient pressure when out of contact with an aqueous liquid. The cleaning article can be substantially completely water soluble at a temperature of about 15° C. to about 30° C. in a time of about 0.5 minutes to about 10 minutes. The detergent composition can comprise one or more materials selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), laundry booster(s), and combinations thereof. The water soluble polymer can be a polyethylene glycol (PEG) polymer. The PEG polymer can have a molecular weight of about 8,000 Da to about 20,000 Da. The water soluble polymer can comprise about 2% to about 75% by weight of the foam structure. The water soluble polymer can comprise about 10% to about 50% by weight of the foam structure. The foam structure can be positioned between a first outer layer and a second out later that each, independently, is solid, porous, and formed of a second water soluble polymer that is the same as or different from the water soluble polymer intermixed with the detergent composition to define the foam structure. One or both of the first outer layer and the second outer layer can comprise a cleaning component retained within the layer. The cleaning component retained within one or both of the first outer layer and the second outer layer can be a surfactant. The first outer layer and the second outer layer each can be configured as a sheet with a porosity, measured as pore void volume divided by a total sheet volume, the porosity being about 10% to about 90%. The first outer layer and the second outer layer each can comprise a polyvinyl alcohol material.

In one or more embodiments, the present disclosure can provide a cleaning article comprising: a first outer layer, a second layer, and an intermediate layer. The first and second layer can be solid, porous, and formed of a water soluble polymer. The intermediate layer can include a plurality of individual filling compositions positioned between the first outer layer and the second outer layer so that the cleaning article is configured as a sheet. In particular, at least one of the plurality of individual filling compositions can be defined as a cleaning article comprising: a detergent composition; and a water soluble polymer having a melting point in the range of about 40° C. to about 80° C.; wherein the detergent composition and the water soluble polymer are intermixed and define a foam structure. Each of the plurality of individual filling compositions comprise one or more cleaning components and exhibit visually distinct colors that results in the intermediate layer having a colored pattern. The intermediate layer is configured to have a thickness and having a length and a width that are each individually greater than the thickness of the sheet. The arrangement allows the colored pattern of the intermediate layer to be visible through one or both of the first outer layer and the second outer layer. In further embodiments, the cleaning article can be defined in relation to one or more of the following statements, which can be combined in any number and/or order. One or both of the first outer layer and the second outer layer can comprise a cleaning component retained within the layer. The cleaning component retained within one or both of the first outer layer and the second outer layer can be a surfactant. The water soluble polymer forming one or both of the first outer layer and the second outer layer can include polyvinyl alcohol (PVOH). The polyvinyl alcohol can be partially hydrolyzed and can have a molecular weight of about 25 Kg/mol to about 100 Kg/mol. One or both of the first outer layer and the second outer layer can be configured as a solid foam. One or more cleaning components in each of the plurality of individual filling compositions can be selected from the group consisting of surfactants, enzyme(s), stabilizer(s), dye(s), optical brightener(s), anti-redeposition agent(s), fluorescent whitening agent(s), fragrance(s), chelating agent(s), foam regulators, corrosion inhibitors, dye transfer inhibitors, softeners, fragrances, pH control & buffers, antioxidants, viscosity builders, formulation aids, bittering agent(s), thickener(s), antifoaming agent(s), pH adjustor(s), bleach(es), fabric softener(s), pearl luster agent(s), preservative(s), laundry booster(s), and combinations thereof. The visually distinct colors of each of the plurality of individual filling compositions can correspond to a cleaning function. A brightness of the visually distinct colors of each of the plurality of individual filling compositions can be greater in a cross-sectional view of the cleaning article than when viewed through one or both of the first outer layer and the second outer layer. At least one of the visually distinct colors can be a blue color defined by L*a*b* values of about 64, about −14, and about −20, respectively. At least one of the visually distinct colors can be a green color defined by L*a*b* values of about 75, about −10, and about 8, respectively. At least one of the visually distinct colors can be a purple color defined by L*a*b* values of about 75, about 5, and about −7, respectively. The cleaning article can be configured with a ratio of length to width (L:W) of about 1:1 to about 10:1. The cleaning article can be configured with a ratio of length to thickness (L:T) of about 10:1 to about 200:1. The cleaning article can be configured with a ratio of length to thickness (L:T) of about 1:1 to about 20:1. The first outer layer, the second outer layer, and the intermediate layer have individual thicknesses, and wherein a ratio of the individual thickness of either of the first outer layer or the second outer layer to the individual thickness of the intermediate layer can be about 0.05:1 to about 2:1. The colored pattern can be an alternating striped pattern. One or both of the first outer layer and the second outer layer can have a transparency of about 5% to about 50%. The intermediate layer can be configured as a semi-solid with a degree of flowability. The semi-solid can have a complex modulus (G*) of no less than 5,000 Pa. The first outer layer and the second outer layer can be configured to be substantially completely water soluble at about 15° C. and at about 30° C. in a time of about 0.5 minutes to about 10 minutes. The first outer layer and the second outer layer each can be configured as a sheet with a porosity, measured as pore void volume divided by a total sheet volume, the porosity being about 10% to about 90%. The plurality of individual filling compositions forming the intermediate layer can include at least two of: a cleaning composition, an odor elimination composition, a softening composition, a bleaching composition, an enzymatic composition, and a booster composition. The article can comprise two intermediate layers separated by a divider layer to provide an overall structure of, from top to bottom, the first outer layer, a first intermediate layer, the divider layer, a second intermediate layer, and the second outer layer.

In one or more embodiments, the present disclosure can provide a method of preparing a cleaning article. As a non-limiting example, such method can comprise: combining a detergent composition with a water soluble polymer that has a melting point in the range of about 40° C. to about 80° C.; heating the detergent composition combined with the water soluble polymer above the melting point of the water soluble polymer to form a flowable detergent/polymer mixture; aerating the flowable detergent/polymer mixture to form a flowable foam; and cooling the flowable foam to form a substantially solid foam structure. In further embodiments, the method can be defined in relation to one or more of the following statements, which can be combined in any number and/or order. One or both of the combining and the heating can be carried out with mixing. The flowable detergent/polymer mixture can have a density of about 0.2 g/cm³ to about 0.5 g/cm³. The aerating can comprise mixing with a high speed mixer. The aerating can comprise blowing a gas into the flowable detergent/polymer mixture. The substantially solid foam structure can be substantially non-flowing at a temperature of less than 40° C. and at ambient pressure when out of contact with an aqueous liquid. The method further can comprise casting the flowable foam so that the substantially solid foam structure exhibits a defined shape of defined dimensions. The method further can comprise combining the flowable foam with at least one sheet that is solid, porous, and formed of a second water soluble polymer that is the same as or different from the water soluble polymer in the flowable foam. The substantially solid foam structure and the at least one sheet ca have a substantially identical length and a substantially identical width. Further to the above, the present disclosure can provide a cleaning article prepared according to the method described above or otherwise discussed herein. In particular, the cleaning article prepared by the method can exhibit any of the characteristics otherwise exhibited by the cleaning articles described herein, such as being substantially completely water soluble at a temperature of about 15° C. and a temperature of about 30° C. in a time of about 0.5 minutes to about 10 minutes.

### BRIEF DESCRIPTION OF THE DRAWINGS

Having thus described aspects of the disclosure in the foregoing general terms, reference will now be made to the accompanying drawings, which are not necessarily drawn to scale. The drawings are examples only, and should not be construed as limiting the disclosure.

FIG. 1 illustrates an example unit dose laundry detergent article configured as a multi-layer sheet according to embodiments of the present disclosure.

FIG. 2 is a graph depicting complex modulus versus stress according to embodiments of the present disclosure.

FIG. 3 is a photo depicting a water soluble sheet material sandwiching a detergent formulation, according to embodiments of the present disclosure.

FIG. 4. illustrates another example unit dose laundry detergent article according to embodiments of the present disclosure.

FIG. 5 is an illustration of a method of producing a unit dose laundry detergent article according to embodiments of the present disclosure.

FIG. 6 is an illustration of another method of producing a unit dose laundry detergent article according to embodiments of the present disclosure.

FIG. 7 is an illustration of a method of altering size parameters of a sheet material according to embodiments of the present disclosure.

FIG. 8 is a graph illustrating dissolution percentage as a function of the weight fraction of one component for a composition according to an example embodiment of the present disclosure.

FIG. 9 is a graph illustrating pH change as a function of time for compositions according to an example embodiment of the present disclosure.

FIG. 10 is a graph illustrating dissolution percentage as a function of the weight fraction of one component for a composition according to an example embodiment of the present disclosure.

FIG. 11 is a graph illustrating pH change as a function of time for compositions according to an example embodiment of the present disclosure.

FIG. 12 is a graph illustrating changes in the complex modulus as a function of applied shear stress for slurry compositions according to an example embodiment of the present disclosure.

FIG. 13 is a graph illustrating dissolution times for cleaning articles prepared using solid foam structures formed from mixtures of a detergent concentrate with two different water soluble polymers.

### DETAILED DESCRIPTION OF THE DISCLOSURE

The present disclosure now will be described more fully hereinafter with reference to the accompanying drawings. The disclosure may be embodied in many different forms and should not be construed as limited to the embodiments set forth herein; rather, these embodiments are provided so that this disclosure will satisfy applicable legal requirements. Like numbers refer to like elements throughout. As used in this specification and the claims, the singular forms “a,” “an,” and “the” include plural references unless the context clearly dictates otherwise.

In one or more embodiments, the present disclosure provides cleaning articles, such as, for example, laundry detergents. The cleaning articles can be provided as substantially solid articles so that they are capable of being handled directly by a consumer and substantially retain their shape throughout such handling. A cleaning article according to the present disclosure can be defined as a single object that can be a single mass of a substantially uniform composition. A cleaning article alternatively can be defined as a single object that can be a combination of a plurality of discrete masses, compositions, layers, sections, pieces, or the like. In certain embodiments, a cleaning article according to the present disclosure can be shaped so as to be substantially sheet-like and thus may be defined by a single sheet or may comprise a plurality of distinct layers, one or more of which is sheet-like in shape. In various embodiments, one, two, three, four, or even more outer layers may be utilized and thus may be referenced as a first outer layer, a second outer layer, a third outer layer, and so on. Any one or more outer layers used in the present articles may be referenced as “sheets”, “outer sheets”, or “retaining sheets” in light of one functional aspect of the sheets as retaining a filling material therebetween.

In some embodiments, a cleaning article according to the present disclosure can comprise, in addition to a plurality of outer layers, at least one “intermediate layer”, which also may be referenced as a “filler layer”, “filling layer”, or simply a “filling”. The term “intermediate” in this usage indicates positioning of the layer relative to the outer layers or retaining sheets. The intermediate layer/filling can comprise a plurality of distinct filling compositions. In some embodiments, the first outer layer and the second outer layer may be two distinct and separate layers, but the first outer layer and the second outer layer can, in some embodiments, be defined by a single retaining sheet that is folded over so that the intermediate layer is between the portion of the single sheet that defines a first outer layer and the portion of the single sheet that defines a second outer layer. In some embodiments, the intermediate layer filling compositions can be referenced as being “sandwiched” between at least a first outer layer or retaining sheet and a second outer layer or retaining sheet.

In another embodiment, three or more retaining sheets can be used. For example, a cleaning article can be configured so that a first retaining sheet and a second retaining sheet are arranged as outer layers, and at least a third retaining sheet is arranged as a divider layer, the term divider in this usage indicating positioning of a divider layer relative to at least two intermediate or filling layers. In such embodiments, a first intermediate layer or filling can be arranged between the first outer layer and the divider layer, and a second intermediate layer or filling can be arranged between the second outer layer and the divider layer. Each of the first and second intermediate layers can comprise a plurality of distinct filling compositions, and each of the first and second intermediate layers can have different overall compositions and/or combinations of compositions. In some embodiments, each intermediate layer comprises the same filing compositions, but each the intermediate layers can, in some embodiments, have alternating or different compositions. In some embodiments, the intermediate layer compositions can be referenced as being “sandwiched” between a first outer layer and a second outer layer, “sandwiched” between an outer layer and a dividing layer, or “sandwiched” between two diving layers. In some embodiments, a dividing layer can be referenced as being “sandwiched” between a first intermediate layer and a second intermediate layer. As a non-limiting example, a cleaning article can comprise, from top to bottom, a first outer layer, an intermediate layer, and a second outer layer. As another non-limiting example, a cleaning article can comprise, from top to bottom, a first outer layer, a first intermediate layer, a divider layer, a second intermediate layer, and a second outer layer. As a further non-limiting example, a cleaning article can comprise, from top to bottom, a first outer layer, a first intermediate layer, a first divider layer, a second intermediate layer, a second divider layer, a third intermediate layer, and a second outer layer. In each of the foregoing, any of the intermediate layers may comprise a single composition or may comprise a plurality of distinct compositions that are separately arranged to form the intermediate layer. Likewise, in each of the foregoing, any of the first outer layer, second outer layer, first divider layer, and second divider layer can have the same composition or may have different compositions.

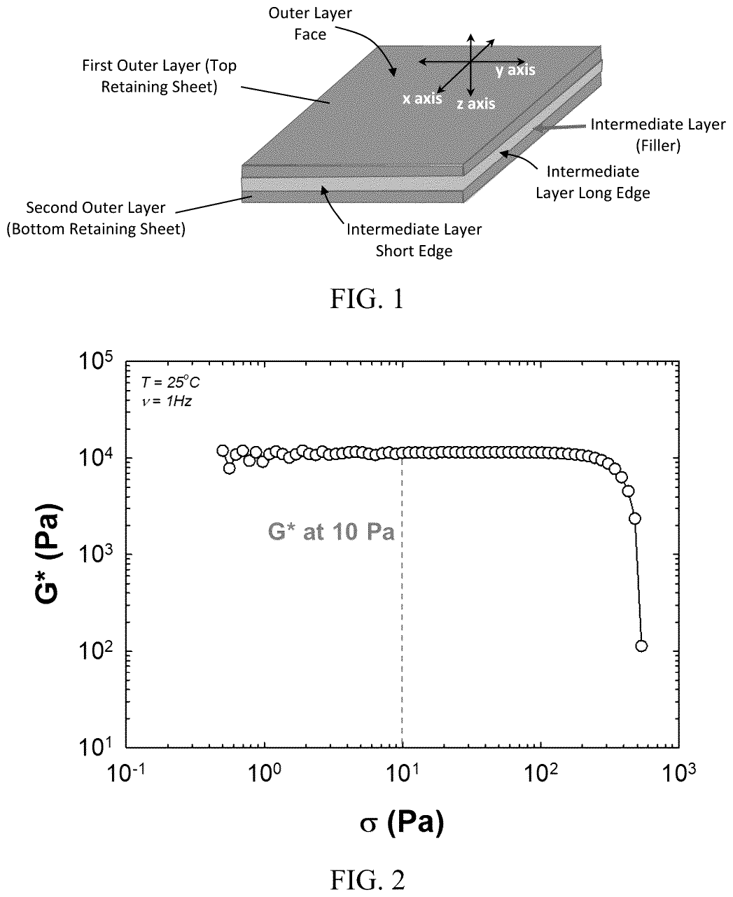

An example embodiment of a cleaning article according to the present disclosure is shown in FIG. 1. Specifically, the article comprises two retaining sheets, which can be characterized as a first outer layer and a second outer layer, and an intermediate layer, which can be characterized as being a filling or filler. The article can be configured so that the filler is in direct contact with the outer layers (or generally retained by the outer layers). The articles of the present disclosure are particularly configured so that the outer layers will rapidly dissolve in water or other aqueous liquid suitable for use with cleaning articles. Rapid dissolution beneficially accelerates the diffusion and/or dissolution of the filler in the water as well.

Cleaning articles of the present disclosure, when each of the individual layers are combined, can be characterized as being in the overall form of a sheet or a multi-layer sheet. Each cleaning article sheet thus can be a composite of multiple, distinct sheets and filling layer(s). The layered structure is beneficial for positioning certain detergent components in a manner that limits contact with a user, and can limit contact between components. This arrangement is further beneficial since the retaining sheets defining the outer layers and any divider layers can be substantially in the form of a solid while the at least one intermediate layer is less structured and is rather a semi-solid that has a degree of flowability. As further discussed herein, the degree of flowability is preferably limited as measured and defined by having at least a minimum complex modulus (G*) value. In some embodiments, the semi-solid can be configured as a gel or a slurry or a paste. The retaining sheets thus have direct contact with the composition or compositions defining the at least one intermediate layer and are effective to maintain the overall article as a solid, compact article that is easily handled by a consumer. Once the cleaning article has contact with an aqueous medium, such as a laundry wash liquor, the retaining sheets defining the outer layers are exposed to the aqueous medium and will dissolve to fully release the cleaning compositions present in the at least one intermediate layer that is in direct contact with the outer layers. In other embodiments, the filler or intermediate layer can be configured to be substantially solid, such as being in the form of a substantially solid foam structure. Providing the filler or intermediate layer as a solid foam structure can improve stability of the cleaning article while still enabling a suitable dissolution time in a wash water.

In embodiments comprising at least two intermediate layers and one or more dividing layers, the dividing layers may exhibit a delayed release of any cleaning material retained therein relative to the outer layers. In particular, as the intermediate layer(s) dissolve(s) in the aqueous medium, the dividing layer becomes exposed to the aqueous medium and dissolves into the aqueous medium.

Because the retaining sheets defining the outer layers are configured to have a substantially high porosity, water can diffuse into and out of the outer layers to begin dissolution of the compositions in the at least one intermediate layer before the outer layers have themselves fully dissolved. Any divider layers that are present likewise can exhibit similar porosity and water diffusion capability. Additionally, one or more cleaning agents may be incorporated into the structure of the retaining sheets, and such cleaning agents may be rapidly released as the water infiltrates the retaining sheets through the many pores.

The intermediate layer(s) used in the present cleaning articles are specifically configured to exhibit a high degree of water solubility while having a storage stable physical structure, meaning that a composition used in the intermediate layer will not flow or otherwise leak out of the article (e.g., bulge or flow outward from between the outer layer and/or seep through pores in the outer layers). As further described herein, this can be achieved in various manners depending upon the desired physical structure of the intermediate layer composition. In some embodiments, an intermediate layer composition can be in a semi-solid form, such as a gel, a slurry, a paste, or a dough, that exhibits sufficient structure to avoid flowing or leaking, as noted above. In other embodiments, an intermediate layer composition can be in a form of a substantially solid foam structure that likewise avoids flowing or leaking from the cleaning article. In one or more embodiments, a specific state may be expressly excluded. For example, the intermediate layer composition may specifically not be in the form of a gel, may specifically not be in the form of a slurry, may specifically not be in the form of a paste, or may specifically not be in the form of a foam. The cleaning articles further can retain their original chemical and physical properties described herein over a relatively wide temperature range, such as might be encountered in storage. In addition, the retaining sheets (or outer layers) can be in a form that allows a semi-solid composition forming the at least one intermediate layer to diffuse therethrough when in contact with an aqueous medium. Nevertheless, the retaining sheets are configured such that a significant content of the intermediate layer compositions do not escape or leak from the cleaning article, or through the outer layers, prior to use. The outer layers likewise can be configured for diffusion of water therethrough (e.g., through a network of interconnected pores) to expedite dissolution of the intermediate layer(s), particularly when a solid foam structure is utilized.

The structural arrangement of the several components of the disclosed cleaning articles can increase efficiency of the cleaning article as, for example, a laundry detergent. For example, the high surface area of the cleaning article, when arranged in a sheet form, can increase the rate of diffusion of the intermediate layer compositions through the outer layers. Likewise, the retaining sheets can be configured to facilitate diffusion of the intermediate layer compositions in an aqueous medium, while also limiting exposure of the components of the intermediate layer compositions to consumers when handling the cleaning article, and also limiting the intermixing of any separated components through the retaining sheets prior to use. For example, certain components, such as enzymes or basic materials can be irritating to skin, and the cleaning article can still include such materials in the intermediate layer while the outer layers have compositions that are substantially non-irritative. The dissolution rate of the intermediate layer composition(s) and the outer layers directly affects the efficiency and performance of the cleaning article. For example, providing for a faster release of the components of the cleaning article into the washing liquid can increase the likelihood that substantially the entirety of the cleaning article components are dispersed during the wash cycle to provide their individual cleaning functions. Furthermore, a faster dissolution rate can be more environmentally friendly due to a shortened wash cycle, resulting in less water and power usage during laundering. In some embodiments, the porosity of the retaining sheets may form a gradient, with the exposed outer surface of the Retaining sheet being more porous than the inner surface in direct contact with the intermediate layer. A less porous inner surface in direct contact with the intermediate layer can provide for increased retention of the intermediate layer composition, and a more porous outer surface can provide for increased water penetration and a faster dissolution rate. As such, one or both of pore size and porosity (or pore percentage) can increase across the thickness of the retaining sheet from an inner surface to an outer surface.

The cleaning articles described herein can be provided in a variety of shapes and sizes, and these can be dictated, at least in part, by the overall shape of the retaining sheets. For example, the outer layers, and thus the overall cleaning article when viewed from the top or bottom, can be substantially in the form of a square, rectangle, parallelogram, triangle, circle, or other shape, but conveniently may have a rectangular or square shape when viewed normally to the plane of its two longest dimensions. A rectangular or square cleaning article may be more easily manufactured than other configurations when using conventional packaging equipment.

The disclosed cleaning articles can be provided in different sizes and weights (e.g., small, medium, large) to accommodate different consumer needs. The sizes can correspond to a recommended detergent dose for laundry fabric loads or levels of soil. Further, the retaining sheets, independently, may have smaller, larger, or equal thickness to the at least one intermediate layer compositions. The weight and dimensions of the cleaning articles can be balanced to ensure quick and complete dissolution of the article in the wash water. In various embodiments, the cleaning articles described herein can have a length defined by an upper length of 30 cm and a lower length of 5 cm, the length including all possible ranges bounded by the upper length and the lower length (e.g., 5 cm to 30 cm, 10 cm to 25 cm, etc.) and, as such, every whole number from 5 to 30 (or fractions thereof) is expressly included in this disclosure for defining upper and lower boundaries of the encompassed ranges. Likewise, the length can be “at least” any of the values within the above range or can be “less than” any of the values within the above range. In various embodiments, the cleaning articles can have a width defined by an upper width of 20 cm and a lower width of 3 cm, the width including all possible ranges bound by the upper width and the lower width (e.g., 3 cm to 20 cm, 5 cm to 15 cm. etc.). Likewise, the width can be “at least” any of the values within the above range or can be “less than” any of the values within the above range. In various embodiments, the cleaning articles can have a thickness defined by an upper thickness of 20 mm and a lower thickness of 2 mm, the thickness including all possible ranges bound by the upper thickness and the lower thickness (e.g., 2 mm to 20 mm, 5 mm to 15 mm, etc.) and, as such every whole number between 2 and 20 (or fractions thereof) is expressly included in this disclosure for defining upper and lower boundaries of the encompassed ranges. Likewise, the thickness can be “at least” any of the values within the above range or can be “less than” any of the values within the above range. In some embodiments, such as where a plurality of individual intermediate layers are separated by one or more divider layers, the overall thickness of the cleaning article can be greater, such as being multiplied by a factor of the number of intermediate layers and divider layers. As such, the cleaning article may exhibit a three-dimensional shape of a cube or cuboid, a cylinder, a pentagonal prism, a hexagonal prism, or similar shapes. For example, a cleaning article having a length and width within the ranges already described above may have a total thickness of up to about 100 mm, up to about 80 mm, up to about 50 mm, or up to about 30 mm. In example embodiments of cleaning articles of greater thickness, the cleaning articles can have a thickness defined by an upper thickness of 100 mm and a lower thickness of 10 mm, the thickness including all possible ranges bound by the upper thickness and the lower thickness (e.g., 10 mm to 100 mm, 20 mm to 80 mm, etc.) and, as such every whole number between 10 and 100 (or fractions thereof) is expressly included in this disclosure for defining upper and lower boundaries of the encompassed ranges.

The disclosed retaining sheets can also be provided in different sizes and weights (e.g., small, medium, large) to accommodate different consumer needs. The sizes can correspond to a recommended detergent dose for laundry fabric loads or levels of soil. Further, the retaining sheets may have smaller, larger, or equal thickness to the intermediate layer compositions. The weight and dimensions of the retaining sheets can be balanced to ensure quick and complete dissolution of the layers in the wash water, while limiting gel flow, or creep, of the at least one intermediate layer through the retaining sheets during packaging, shipping, handling, etc.

In various embodiments, the retaining sheets described herein can each, individually have a length and width that is substantially the same as the length and width of the overall cleaning article. In various embodiments, the retaining sheets each can have a thickness defined by an upper thickness of 15 mm and a lower thickness of 0.5 mm, the thickness including all possible ranges bound by the upper thickness and the lower thickness (e.g., 0.5 mm to 15 mm, 0.5 mm to 10 mm, 1 mm to 5 mm, etc.) and, as such, every whole number between 0.5 and 20 (or fractions thereof) is expressly included in this disclosure for defining upper and lower boundaries of the encompassed ranges. Likewise, the thickness can be “at least” any of the values within the above range or can be “less than” any of the values within the above range. In certain embodiments, where at least one divider layer is present, the at least one divider layer can have a size and/or weight that is equal to the size and/or weight of each of the outer layers. The at least one divider layer can be the same length, width, and thickness of each outer layer, however, in some embodiments, the at least one divider layer can have a different length, width, thickness, or a combination thereof, than each of the outer layers.

In various embodiments, the intermediate layer(s) described herein can have a length and/or width that is less than or equal to the length and/or width of the outer layers. Providing an individual intermediate layer with a length and/or width that is smaller relative to the length and/or width of the retaining sheets may allow extra room for the intermediate layer (particularly when in the form of a semi-solid material) to flow outward during packaging, shipping, handling, or use to ensure extra room for gel flow or creep to prevent the intermediate layer from creep beyond the outer boundaries or edges of the retaining sheets.

An individual intermediate layer can range in thickness based on weight, specific gravity, and viscosity of its form, and the quantity of the cleaning composition to achieve optimum cleaning results. In some embodiments, an individual, intermediate layer can have a thickness defined by an upper thickness of 15 mm and a lower thickness of 0.5 mm, the thickness including all possible ranges bound by the upper thickness and the lower thickness (e.g., 0.5 mm to 15 mm, 0.5 mm to 10 mm, 1 mm to 5 mm, etc.) and, as such every whole number between 0.5 and 20 (or fractions thereof) is expressly included in this disclosure for defining upper and lower boundaries of the encompassed ranges. Likewise, the thickness can be “at least” any of the values within the above ranges or can be “less than” any of the values within the above ranges. The cleaning articles further can be characterized in relation to ratios of length to width and/or length to thickness. In some embodiments, the cleaning article can have a ratio of length to width (i.e., L:W) of about 1:1 to about 10:1, about 1:1 to about 5:1, or about 1:to about 3:1. In some embodiments, the cleaning article can have a ratio of length to thickness (L:T) of about 10:1 to about 200:1, about 15:1 to about 100:1, or about 20:1 to about 80:1. As noted above, however, thicker embodiments are also encompassed by the present disclosure, and the L:T ratio of such embodiments can be about 1:1 to about 20:1, about 2:1 to about 15:1, or about 3:1 to about 12:1. Ratios of width to thickness (W:T) can be within the same ranges as the L:T ratios with the W:T ratio being equal to or less than the L:T ratio. Ratios of an individual retaining sheet (e.g., outer layer or divider layer) thickness to an individual intermediate layer (e.g., an individual filler layer formed of a plurality of different compositions) thickness (Tr:Tf) can be about 0.05:1 to about 2:1, about 0.1:1 to about 2:1, about 0.5:1 to about 1.5:1, or about 0.8:1 to about 1.2:1.

The overall cleaning article can be provided in dimensions that can provide improved dissolution and diffusion of the various components of the cleaning articles that arise from the combination of the outer layers and the intermediate layer compositions. Non-limiting, example embodiments include: length of about 130 cm, width of about 100 cm, and thickness of about 1-10 mm; length of about 15 cm, width of about 10 cm, and thickness of about 0.5-5 mm; length of about 11 cm, width of about 7 cm, and thickness of about 0.5-5 mm; length of about 10 cm, width of about 6.5 cm, and thickness of about 0.5-5 mm; length of about 6.5 cm, width of about 5 cm, and thickness of about 0.5-5 mm.

The foregoing dimensions and ratios can be specifically chosen to provide improved dissolution and diffusion of the various components of the cleaning articles that arise from the combination of the retaining sheets and the intermediate layer compositions. The dimensions likewise can be balanced with the weight of the intermediate layer compositions in order to provide fast and complete dissolution of the cleaning article, in a manner that is not otherwise attainable by the articles known in the industry or disclosed by the art.

In one or more embodiments, dissolution can be associated with the surface area of the various layers for interacting with wash water. With reference again to FIG. 1, a laundry article according to the present disclosure including at least one outer layer and at least one intermediate layer can be defined in relation to the outer surfaces of the article. Each outer layer (retaining sheet) that is present defines a face surface with an area calculable as a product of the length and the width of the outer layer. While the intermediate layer is covered on both the top and bottom by the outer layer, the intermediate layer is uncovered or unobstructed by the one or more outer layers at the edges of the article. A single intermediate layer edge has an area calculable as a product of the length of the edge and the average thickness of the intermediate layer at said edge. In the embodiment of FIG. 1, the article is configured substantially as a rectangle with two long edges of approximately the same length and two short edges of approximately the same length. The total edge area of the intermediate layer is thus the sum of the areas of each individual edge.

The area of the open edges of the laundry article relative to the area of the face(s) of the laundry article can be determined based upon competing interests. Since rapid and substantially complete dissolution of the laundry article is beneficial for maximizing cleaning efficacy of the laundry article, it can be useful for the laundry article to have a relatively large edge surface area for contact with wash water. On the on other hand, as the intermediate layer composition make take on a variety of forms that are not solid, leaking or creep of the intermediate layer past the open edges is to be minimized or avoided. The presence of the outer layer retaining sheet(s) can be configured to assist in immobilizing the intermediate layer and preventing creep, and providing the outer layer(s) as porous sheets can allow for increasing this immobilizing effect without overly limiting dissolution rate of the intermediate layer composition(s) in the wash water.

In light of the foregoing, in one or more embodiments, the laundry articles can be configured with a specified Edge to Face Area Ratio (“EFAR”), where the edge is the edge of the intermediate layer on all sides of the article that are open and unobstructed by the outer layer(s), and the face encompasses the face of each outer layer present in the article. For example, a single face may be defined by a single outer layer that is folded over with an intermediate layer therebetween, and two faces may be defined by two outer layers positioned on opposing sides of the intermediate layer (as in FIG. 1). The EFAR of a laundry article according to the present disclosure may be configured to be less than 0.5, less than 0.4, less than 0.2, or less than 0.1, and may have a lower boundary of at least 0.01. In one or more embodiments, the EFAR may be in the range of about 0.01 to about 0.5, about 0.02 to about 0.4, or about 0.03 to about 0.2. In one or more embodiments, the EFAR may be in the range of about 0.01 to about 0.2, about 0.015 to about 0.15, about 0.02 to about 0.1, or about 0.025 to about 0.09.

Each retaining sheet can be configured as a solid sheet or pad that is porous and that is formed of a water soluble material. In various embodiments, the retaining sheets of the present disclosure are not configured as a film. A film configuration indicates that the material is a continuous or uninterrupted sheet of material. A film configuration also indicates a very thin material, on the order of less than 0.2 mm or less than 0.1 mm. The configuration of the retaining sheets of the present disclosure rather indicates a material of greater thickness (as already discussed above) and indicates that the material includes a plurality of voids, pores, or other discontinuities formed therein so that when an intermediate layer is sandwiched between retaining sheets, the intermediate layer compositions are in direct communication with the surrounding atmosphere through the discontinuities of the retaining sheets. This allows, when exposed to water, the simultaneous dissolution of the outer layers and diffusion of the intermediate layer compositions through the discontinuities of the outer layers.

The retaining sheets can be prepared from any material suitable to provide the outer layers, and if present, divider layer(s), with the desired physical characteristics (e.g., solubility, porosity, and structure). In particular embodiments, the retaining sheets can be made from a water soluble compound or water soluble polymer. In various embodiments, the structural material of the retaining sheets is substantially water soluble or completely water soluble. Solubility can be characterized as a measure in, for example, minutes at a specific water temperature under agitation or stirring. The materials useful in the water soluble materials described herein can be partially, substantially completely, or completely water soluble in both cold water (e.g., 15° C.) and warm water (e.g., 30° C.) conditions (as well as intervening temperatures). Completely water soluble is understood to mean at least 99.9% by weight of the polymer is solubilized in the water, and substantially completely water soluble is understood to mean at least 98%, at least 98.5%, at least 99%, or at least 99.5% solubilized in the water.

The time that the retaining sheets take to completely, or substantially completely solubilize in water, or dissolution time, is indicative of product performance. For example, a retaining sheet that takes longer to dissolve, provides less time for the laundered materials to be exposed to the cleaning components during a wash cycle. The materials useful in the retaining sheets described herein are preferably completely or substantially completely water soluble with moderate stirring within a time period of about 0.5 minutes to about 10 minutes in both cold water and warm water, as defined above.

Dissolution time of the retaining sheets is directly affected by the permeability, porosity (and corresponding degree of aeration), thickness, and/or other parameters of the water soluble material. Configuring the outer layers with a high permeability can provide for faster dissolution of the material forming the outer layers as well as faster infiltration of water, which facilitates dissolution of the intermediate layer compositions. In various embodiments, the retaining sheets described herein can have a permeability which ensures that liquid from the wash water permeates the outer layers and provides a desirable rate of the simultaneous dissolution of the retaining sheets and the intermediate layer compositions. Because permeability can be defined relative to a pore size, optimizing permeability while maintaining the retention of the intermediate layer composition prior to use must be considered. In various embodiments, the retaining sheets can have pore sizes such that a significant portion of the intermediate layer compositions retained between the retaining sheets does not escape prior to use. In some embodiments, the porosity can be configured to achieve the desired dissolution characteristics of the retaining sheets and intermediate layer compositions through pores in the retaining sheets, while limiting consumer exposure to the intermediate layer during handling. In practice, an advantage of this configuration is lowering or eliminating consumer exposure to potential irritants such as enzymes, caustics, acidifiers, perfumes, or microcides of the intermediate layer composition when handling.

Porosity can be determined qualitatively by a visual examination of the pore size of the retaining sheets. In some embodiments, the porosity can be defined in relation to the average size of pores within each retaining sheet. In various embodiments, the retaining sheets can have an average pore size of about 10 to 300 microns or about 50 to 250 microns in diameter. This can be evaluated using microscopy for pore counting, such as SEM. More commonly, however, porosity is instead measured by sheet density (mass per volume), which also offers higher accuracy. In the disclosed retaining sheets, porosity can be defined as the fraction of void space in the material, where the void contains air. Specifically, porosity can be determined by dividing the volume of the voids within the retaining sheet by the total volume of the retaining sheet. In one or more embodiments, porosity (mass per volume) can range from about 0.3 to about 1.5 depending on ingredients and load. In some embodiments, the porosity of each retaining sheet can be defined by the percentage of the volume of a retaining sheet accounted for by the pores (i.e., porosity=pore void volume/total sheet volume), with an upper limit of 0.9 (90%) and a lower limit of 0.1 (10%), the percentage of porosity including all possible ranges bounded by the upper limit and the lower limit (e.g., 10% to 90%, 20% to 80%, 30% to 70%, etc.) and, as such, every whole number from 10 to 90 is expressly included in this disclosure for defining upper and lower boundaries of the encompassed ranges. Likewise, the percentage of porosity can be “at least” any of the values within the above range or can be “less than” any of the values within the above range.

The retaining sheet may be provided in any configuration with the porosity as already described. In one or more embodiments, the retaining sheets may be configured as a foam. In one or more embodiments, the retaining sheets may be configured as a woven fabric. In one or more embodiments, the retaining sheets may be configured as a non-woven fabric.

In various embodiments, the retaining sheets described herein provide the means of holding the intermediate layer and the structural foundation of the cleaning article disclosed herein, while providing a desirable rate of the simultaneous dissolution of the retaining sheets and the intermediate layer compositions. Because the type of solubility of a material and structural stability are often inversely related, the material of the retaining sheets must be considered for its effect on dissolution. In some embodiments, the material of the retaining sheet can comprise a structural polymer of polyvinyl alcohol, polyethylene oxide, methyl cellulose, cellulosic or silica reinforcing agents, or mixtures thereof. Among polyvinyl alcohols, the partially hydrolyzed grades are preferred, especially in the range 87-89% hydrolyzed. The molecular weight can be in the range of about 25 Kg/mol to about 100 Kg/mol, with a molecular weight of about 30 Kg/mol to about 50 Kg/mol being preferred. Molecular weight may be measured as a number average (Mn) or a weight average (Mw). Unless otherwise stated, molecular weights described herein are based on the weight average. Other polymers may include starch, poly(vinyl pyrrolidone), poly(vinylpyrrolidone-co-vinyl acetate), polyacrylic acid and related copolymers, alginate, carrageenan, and gums such as xanthan and locust bean.

The structural polymer may be intentionally segregated from the intermediate layer compositions, such as detergent or caustic solubilizers, to protect the stability of the disclosed cleaning article during its manufacture at high temperatures (typical 90-100° C.). In certain formulation embodiments, the material of the retaining sheets are processed in an aqueous fluid scenario where this aqueous portion is maintained at an acidic pH (pH 5-6) at the drying temperatures of 90-100° C. in order to keep the structural polyvinyl alcohol lattice from coexistence with the high pH (pH 8.0-11.0) of the caustic detergent phase. Allowing for the preformation and drying of the low pH retaining sheet material serves to protect the physical integrity of the dry polyvinyl alcohol lattice from the caustic pH of the intermediate layer composition, which is added by the process post drying of the retaining sheet material, thus preserving both the acid nature of the retaining sheet material, along with the caustic nature of the intermediate layer compositions. This helps insure a stable retaining sheet material, and stable intermediate layer compositions, due to at least in part, the lower temperature processing or manufacture in an aqueous environment. Both the retaining sheet material and the intermediate layer compositions remain stable with integrity until the cleaning article is eventually put into the aqueous environment of the washing machine, upon which the retaining sheets and intermediate layer dissolve with dissolution of the polyvinyl alcohol aided by the presence of the wash water.

In one or more embodiments, the retaining sheets described herein can be configured to include, in addition to the water soluble material itself, one or more components that are typically useful in detergent formulations. Useful formulations can include any one or more of the following components (each of which may be present singly or as a plurality of different members of the noted group): surfactants, chelators, builders, alkalinizing agents, viscosifiers, bicarbonates, enzymes, enzyme stabilizers, dyes, optical brighteners, antiredeposition polymers, fluorescent whitening agents, fragrances, bittering agents, antifoaming agents, pH adjustors, bleaches, pearl luster agents, preservatives, and laundry boosters such as fabric softeners, fabric conditioning agents, and disintegrants, such as sodium starch glycolate. In this embodiment, any embedded component does not introduce undesired effects on the clothing or other fabric articles that are being laundered using the disclosed article, dissolves as discussed above in laundry washing conditions, and has a suitably low melting point to provide for ease of combining with other components of the water soluble materials disclosed herein. In practice, the embedded component can provide additional detergent properties.

The cleaning articles according to the present disclosure comprise one or more fillers or filling layers (i.e., the intermediate layer compositions) retained between the retaining sheets. Because the retaining sheets are porous, the intermediate layer compositions can be provided in a variety of forms, such as being provided in a semi-solid (e.g., a gel, slurry, paste, or dough) and/or a solid or substantially solid form, such as a foam form (e.g., a substantially solid foam structure). Likewise, when a divider layer is present, such divider layer may be in a substantially solid form, such as a porous sheet similar or identical to an outer layer sheet, as otherwise described herein. The intermediate layer compositions can be specifically configured to begin diffusion through the retaining sheets almost immediately upon contact of the cleaning article with water due to the rapid infiltration of water through the pores of the retaining sheets. The intermediate layer compositions are also configured to achieve rapid dissolution during use, while still being retained between porous material.

The intermediate layer compositions (i.e., fillers, or filler compositions) used in a cleaning article according to the present disclosure can include any number of cleaning components that are typically useful in detergent compositions. The individual intermediate layer compositions can be characterized as comprising one or more cleaning components with it being understood that the phrase “cleaning component” indicates that it is a component useful in a laundry detergent composition. While some components of typical laundry detergents (e.g., dyes, fragrances, antifoaming agents, etc.) are not provided to clean in the sense of removing soils or odors from laundry items, such components are still considered to be cleaning components according to the present disclosure in that they may be present in compositions that are included in an overall cleaning article. Useful components in a laundry detergent composition, and thus in a laundry detergent formulation according to the present disclosure, can include any one or more of the following components (each of which may be present singly or as a plurality of different members of the noted group): surfactants, chelators, builders, alkalinizing agents, viscosifiers, bicarbonates, enzymes, enzyme stabilizers, dyes, optical brighteners, antiredeposition polymers, fluorescent whitening agents, fragrances, bittering agents, antifoaming agents, pH adjustors, bleaches, pearl luster agents, preservatives, and laundry boosters such as fabric softeners, fabric conditioning agents, and disintegrants, such as sodium starch glycolate. Any of the above components, as well as other components typically found in such products, can be utilized in any composition or formulation as described, irrespective of form or intended use. In other words, an individual intermediate layer composition used in a cleaning article of the present disclosure can comprise any one, two, three, four, five, six, seven, eight, nine, or more components falling within any one, two, three, four, five, six, seven, eight, nine, or more of the groups of cleaning components listed above. Further, any other component described herein that is not otherwise defined as being required may be optionally, expressly excluded from embodiments of intermediate layer compositions. Any of the foregoing materials may be present one or more of the intermediate layer compositions in amounts of 0% to about 20%, about 0.01% to about 15%, about 0.02% to about 10%, or about 0.05% to about 5.0% by weight based on the total weight of the intermediate layer compositions. In other embodiments, any of the foregoing materials may be present in the intermediate layer compositions in amounts of 0% to about 4.0%, about 0.01% to about 3.0%, about 0.02% to about 2.0%, or about 0.05% to about 1.0% by weight based on the total weight of the intermediate layer compositions.

In one or more embodiments, intermediate layer compositions that are configured as a semi-solid gel, slurry, paste, or dough can exhibit specific rheological properties, such as a specific complex modulus or ranges of complex modulus. Measure of the complex modulus can be effective for illustrating whether a semi-solid intermediate layer composition exhibits sufficient physical properties to prevent flow of the semi-solid intermediate layer compositions through any discontinuities or pores in the outer layers of the cleaning article, while still exhibiting a sufficiently short time to partial dissolution and time to complete dissolution. Preferably, time to complete dissolution is at least within the timeframe of a typical wash cycle (e.g., approximately 10 minutes). With regards to the complex modulus, G* (a measure of the total resistance to flow of a material) can be measured with a commercially available rheometer, such as the Anton Parr model MCR 702e, which was used in the testing described in the appended Examples. To evaluate complex modulus, a sample of a semi-solid material for use in an intermediate layer according to the present disclosure can be placed between two 40 mm diameter circular plates that are spaced apart with a gap therebetween of 1 to 2 mm. The top plate then is oscillated back and forth at a constant frequency of 1.0 Hz (6.28 radians/s) while applying a stress that is ramped from 0.5 to about 700 Pa. The complex modulus at an applied stress of 10 Pa (in the plateau region of the curve) is a useful parameter to characterize the structural integrity of the semi-solid intermediate layer compositions. An example of values resulting from performing such an evaluation method is shown in FIG. 2. In some embodiments, compositions used in the intermediate layer of the present cleaning article that are configured as a gel, a slurry, or a paste preferably can be defined by an upper complex modulus (G*) of 10⁶ Pa and a lower complex modulus (G*) of 10² Pa, the complex modulus (G*) including all possible ranges bound by the upper G* and the lower G* (e.g., 10² Pa to 10⁶ Pa, 10² Pa to 10⁴ Pa, etc.) and, as such every whole number between 10² and 10⁶ is expressly included in this disclosure for defining upper and lower boundaries of the encompassed ranges. Additionally, in some embodiments, gel, slurry, or paste compositions used in the intermediate layer can be defined by a minimum complex modulus of no less than 5,000 Pa, no less than 10,000 Pa, or no less than 15,000 Pa. High complex modulus can be useful to prevent the intermediate layer compositions from flowing out of the edges of the cleaning article (i.e., between the two outer layers) and also to prevent bleed of the intermediate layer compositions through the porous outer layers. The magnitude of the complex modulus may also affect dissolution time of the overall cleaning article, and remaining below a specific range can be beneficial to avoid incomplete dissolution. In some embodiments, gel, slurry, or paste compositions used in the intermediate layer can be defined by a complex modulus preferably in the range of about 5,000 Pa to about 30,000 Pa, about 6,000 Pa to about 25,000 Pa, about 7,000 Pa to about 23,000 Pa, or about 8,000 Pa to about 20,000 Pa.

In one or more embodiments, intermediate layer compositions may include one or more rheology modifiers to assist in suspension of cleaning components that traditionally exhibit low solubility and/or low stability. In particular embodiments, intermediate layer compositions can be in a slurry form comprising one or more suspended components. For example, a bicarbonate slurry may be used to suspend enzymes, optical brightener, etc., and increase the stability of these components. In some embodiments, the slurry may comprise a nonionic surfactant liquid containing a large percentage (e.g. at least 65%) of an alkaline builder, such as potassium carbonate. Additionally, structure may be provided by including one or both of water soluble solids (such as sodium bicarbonate or potassium carbonate) and water insoluble solids (such as a fumed silica, such as Aerosil® R974 (Evonik)). In some embodiments, a semi-solid intermediate layer composition can comprise one or more agents configured to impart sufficient rheological properties to the composition so that the composition can avoid leakage through an exposed end or exposed side of the cleaning article. Higher melt point surfactants can be used, and these can be advantages due to their ability to function as a cleaning component while retaining its polymeric properties that can add the necessary structure to the composition. Alternatively, or additionally, the compositions may comprise one or more water soluble rheology modifiers, such as gel-formers, gums, and the like that can immobilize the formula (i.e., avoid leakage) but readily dissolve in cold water.

In one or more embodiments, an intermediate layer composition can be specifically formed as a solid foam structure. As such, a cleaning article according to the present disclosure can comprise at least one outer layer sheet and at least one intermediate layer that is configured as a solid foam. For example, a single outer layer sheet may be folded over with the at least one intermediate layer positioned therebetween. In some embodiments, a cleaning article according to the present disclosure can comprise a first outer layer sheet, a second outer layer sheet, and at least one intermediate layer that is configured as a solid foam and is positioned between the first and second outer layer sheets. The intermediate layer may comprise a plurality of compositions, and the solid foam may be one or more of the plurality of compositions. When a plurality of intermediate compositions are present, the plurality of intermediate compositions may be selected from any one or more of a solid foam, a gel, a slurry, a paste, or a dough.

The phrase “solid foam” indicates a structure that is characterized by the presence of pores, which can be discrete pores or interconnecting pores, achieved by the specific incorporation of a gas (e.g., air) into the composition when in a liquid or flowable form so that the pores remain upon solidification of the composition into a solid or non-flowable form. A solid foam may be rigid. A solid foam may be flexible. A solid foam may be compressible. In any state, a solid foam is a foam that does not dissipate or reduce to a non-foamed state after achieving the solid state.

In one or more embodiments, solid foam structure useful as an intermediate layer can comprise a cleaning component and a water soluble polymer that are mixed and processed to achieve a foam. Such processing can comprise aeration of a non-foamed, viscous liquid, gel, slurry, or paste to incorporate air. Processing can further comprise drying the composition so that the incorporated or entrained air forms pores, as noted herein.

A cleaning component useful in a solid foam structure intermediate layer can be include any one or more materials useful in detergents, as otherwise described herein. Particularly, a cleaning component an comprise a plurality of materials and preferably is in a substantially concentrated form. As used herein, “concentrated” indicates that the detergent composition is not diluted, or is only minimally diluted, by non-detergent materials, such as water. A concentrated cleaning composition specifically will comprise less than 10%, less than 5%, less than 2%, or less than 1% by weight of non-detergent materials. A non-detergent material is any material that is not typically included in detergent compositions for the purpose of providing a cleaning or detergency purpose. As non-limiting examples, a concentrated detergent or cleaning composition can be a composition wherein at least 90%, at least 95%, at least 98%, or at least 99% by weight of the composition is only components selected from the following list in any number: surfactant(s), enzyme(s), stabilizer(s), optical brightener(s), anti-redeposition agent(s), fluorescent whitening agent(s), chelating agent(s), viscosity builder(s), bleach(es), and pearl luster agent(s). In some embodiments, a useful detergent composition is one that is in a substantially solid form prior to combination with the water soluble polymer. As such, a concentrated detergent composition may be one that is solid (or that includes only components that are solid) at room temperature (e.g., about 25° C.).

A water soluble polymer useful in the foam structure can be the same type of water soluble polymer useful in forming the outer layers or sheets as otherwise described above. In some embodiments, however, different water soluble polymers may be utilized for separately forming the outer layer(s) and for forming the foam structure for the intermediate layer. In various embodiments, the water soluble polymer can comprise about 2% to about 75%, about 10% to about 50%, or about 15% to about 40% by weight of the foam structure.

Suitable water soluble polymers may be particularly defined in relation to the melting point of the polymer. As described below, the solid foam structure can be prepared by mixing the detergent composition with the water soluble polymer and melting the polymer to form a flowable mixture that can be aerated to form a flowable foam and then cooled in the aerated condition to arrive at a solid foam structure. The polymer preferably has a melting point that is sufficiently low to accommodate case of manufacture but that is sufficiently high to ensure that the solid foam structure maintains structural integrity in hotter climates, particularly when subject to storage conditions. In some embodiments, the water soluble polymer can be a polymer with a melting point in the range of about 40° C. to about 80° C., about 45° C. to about 70° C., or about 50° C. to about 65° C. In some embodiments, preferred ranges can be about 40° C. to about 60° C. or about 45° C. to about 55° C.

Selection of cleaning composition and water soluble polymer likewise can be based on the processability of the combined materials. When the materials are intermixed at elevated temperature above the melting point of the polymer, the resulting flowable detergent/polymer mixture preferably is capable of being mixed and aerated to form a flowable foam with a suitably low density. Preferably, the resulting, flowable foam will have a density in the range of about 0.2 g/cm³ to about 0.5 g/cm³, about 0.25 g/cm³ to about 0.45 g/cm³, or about 0.3 g/cm³ to about 0.4 g/cm³. Moreover, the combined materials will harden upon cooling below the melting point of the water soluble polymer and retain the foam structure. This results in a solid, intermediate layer composition with a high degree of porosity that gives the solid foam structure a high surface area that promotes quick water solubility and layer disintegration.

As a non-limiting example, polyethylene glycol (PEG) polymers can be particularly useful as a water soluble polymer in the solid foam structure intermediate layer. A PEG polymer may, in some embodiments, be defined in relation to its molecular weight. For example, particularly useful PEG polymers may have a molecular weight in the range of about 1,000 Da to about 600,000 Da, about 1,500 Da to about 200,000, about 1,800 Da to about 80,000 Da, about 2,000 Da to about 20,000 Da, about 4,000 Da to about 16,000 Da, or about 6,000 Da to about 14,000 Da. In certain embodiments, useful PEG polymers particularly may have a molecular weight in the range of about 2,000 Da to about 4,000 Da, about 4,000 Da to about 6,000 Da, about 6,000 Da to about 8,000 Da, or about 6,000 Da to about 10,000 Da. Non-limiting examples of PEG polymers suitable for use in the present foam structures include those sold under the names Carbowax™ and Pluriol®. Other polymers that may be useful in the foam structures include ethylene oxide (EO) propylene oxide (PO) copolymers. Such materials may include (but are not limited to) an EO-PO-EO type copolymer, such as those commercially available under the trade name Pluronic®, which may be call poloxamers. Another example embodiment of suitable polymers include pyrrolidone-acetate copolymers, such as poly(vinylpyrrolidone-co-vinyl acetate) [PVAc-PVP] copolymers. Likewise, PO-EO-PO co-polymers may be used as well as ethylene diamine that is tetrafunctionally modified with PO-EO block groups-available under the trade name Tetronic®.

A foam structure useful as an intermediate layer preferably will be substantially non-flowing at a temperature of less than 40° C. and at ambient pressure when out of contact with an aqueous liquid. In some embodiments, it will be substantially non-flowing up to a temperature of about 45° C., up to about 50° C., or up to about 55° C. The foam structure likewise will exhibit a solubility in water as otherwise described herein. For example, the foam structure will be substantially completely water soluble at a temperature of about 15° C. to about 30° C. in a time of about 0.5 minutes to about 10 minutes.

A foam structure useful as an intermediate layer can be prepared by combining a cleaning composition as discussed herein with a water soluble polymer as discussed above, particularly a water soluble that has a melting point in the range of about 40° C. to about 80° C. The combination of the cleaning composition and the water soluble polymer next can be heated above the melting point of the water soluble polymer to form a flowable detergent/polymer mixture. Heating can be by any suitable method, such as a hot plate, water bath, heating oven, hot water or steam-jacketed mixing vessel, or the like. The composition also can be configured for spontaneous heat production in a sufficient amount to at least partially melt the water soluble polymer. For example, the composition can be configured to include components that, when combined, react exothermically. Certain surfactants can exhibit an exothermic reaction when combined, or mixing of certain surfactants with other composition components may cause an exothermic reaction. Heating preferably is carried out for a time sufficient to substantially completely melt the water soluble polymer and define a flowable detergent/polymer mixture. The detergent/polymer melt can be mixed prior to heating, during heating, and/or after heating. The degree of mixing can vary and can be sufficient to achieve a substantially uniform mixture of the components so that the detergent composition is substantially homogeneously dispersed throughout the melted polymer in the flowable detergent/polymer mixture.

The method further can comprise aerating the flowable detergent/polymer mixture to form a flowable foam. Aerating can be achieved using any suitable method. In some embodiments, sufficient aeration may be achieved through use of a high speed mixer. In some embodiments, it may be useful to flow gas into the detergent/polymer mixture to accelerate the dispersing of gas pockets through the mixture. Air or an otherwise inert gas may be used for such purpose. As non-limiting examples, arrangements such as a mixer with a whisk attachment, a counter rotating sweep, a screw agitator, or an integral air flow induction system can be used to incorporate sufficient aeration. Suitable branded mixers include Hobart mixers, Tri-Mix™ Turbo-Shear™ mixing systems from Lee Industries, high shear mixers available from Charles Ross & Son company, or Kitchen Aid mixers. In particular, aeration preferably is carried out sufficiently to achieve a relatively low density foam that is flowable at the elevated temperature. Preferably, the heating can continue during aeration to ensure that the detergent/polymer mixture remains fully flowable for processing. Once the desired foaming is achieved, the flowable foam can be cooled to form a substantially solid foam structure. Cooling in particular can be carried out when the flowable foam is deposited into a desired end form for use in a cleaning article. For example, in some embodiments, the foam structure can be suitable for use as a stand-alone cleaning article. In such instances, the flowable foam may be cast or molded into a defined shape of defined dimensions. Even when being combined with other structures, such as the outer layers described herein, the foam structure may be pre-cast or pre-molded into a desired shape and size to be combined with the outer layers or other structures. In some embodiments, the flowable foam may be combined with at least one sheet that is solid, porous, and formed of a water soluble polymer. Such water soluble polymer may be characterized as a second water soluble polymer that is the same as or different from the water soluble polymer in the flowable foam. The flowable foam may cool below the melting point of its water soluble polymer during and/or shortly after depositing on the sheet to thus form the solid foam structure in combination with the at least one sheet. When the foam structure is to be positioned between two sheets, it can be preferable for the foam to remain flowable until after both outer layer sheets are applied with the foam structure therebetween at which time the flowable foam can solidify into the non-flowable, substantially solid foam structure forming an intermediate layer. In some embodiments, the substantially solid foam structure and the at least one sheet can have a substantially identical length and a substantially identical width. This can be achieved via the method of combining the flowable foam with the at least one sheet or further processing can be applied to achieve the desired dimensions (e.g., trimming or cutting away excess sheet material and/or solid foam intermediate layer material). In various embodiments, the present disclosure specifically encompasses a cleaning article prepared according to a method as discussed above.

In one or more embodiments, an intermediate layer composition can be specifically formed as a gel. As such, a cleaning article according to the present disclosure can comprise at least one outer layer sheet and at least one intermediate layer that is configured as a gel. For example, a single outer layer sheet may be folded over with the at least one intermediate layer positioned therebetween. In some embodiments, a cleaning article according to the present disclosure can comprise a first outer layer sheet, a second outer layer sheet, and at least one intermediate layer that is configured as a gel and is positioned between the first and second outer layer sheets. The intermediate layer may comprise a plurality of compositions, and the gel may be one or more of the plurality of compositions. When a plurality of intermediate compositions are present, the plurality of intermediate compositions may be selected from any one or more of a solid foam, a gel, a slurry, a paste, or a dough.

An intermediate layer composition configured as a gel can be readily water soluble. The intermediate layer compositions may be configured to be at least partially immobilized upon application to at least one of the retaining sheets. For example, a formulation comprising higher melt point surfactants and readily water soluble rheology modifiers may immobilize the formulation, while remaining dissolvable in cold water. Immobilization refers to the ability to resist flowing out of the edges of the cleaning article, and sufficiency of immobilization may be characterized in some embodiments in relation to the complex modulus of the formulation, as already discussed above. Such gel formulations may comprise higher chain length ethoxylated alcohols, higher molecular weight polyethylene glycols, gelatins, or a combination thereof.

In one or more embodiments, an intermediate layer composition can be specifically formed as a slurry. As such, a cleaning article according to the present disclosure can comprise at least one outer layer sheet and at least one intermediate layer that is configured as a slurry. For example, a single outer layer sheet may be folded over with the at least one intermediate layer positioned therebetween. In some embodiments, a cleaning article according to the present disclosure can comprise a first outer layer sheet, a second outer layer sheet, and at least one intermediate layer that is configured as a slurry and is positioned between the first and second outer layer sheets. The intermediate layer may comprise a plurality of compositions, and the slurry may be one or more of the plurality of compositions. When a plurality of intermediate compositions are present, the plurality of intermediate compositions may be selected from any one or more of a solid foam, a gel, a slurry, a paste, or a dough.

A slurry composition suitable for use as an intermediate layer can be configured to have the rheological properties otherwise described herein so that the slurry is configured as a semi-solid material that resists or avoids creep. In other words, the slurry can be configured so that, once positioned as the intermediate layer between the one or more outer retaining sheets, the slurry is positionally stable and does not significantly flatten, leak through the porous outer layer sheets, or expand outward between the outer layer sheets.

In example embodiments, a semi-solid intermediate layer composition can be configured as a slurry of one or more alkali metal salts in an aqueous medium (i.e., comprising at least water). Such slurries can readily suspend additional cleaning components, such as enzymes, brighteners, and other components that are typically available in a particulate form. Such slurries particularly can be an advantageous approach for including components that may be unstable and/or have low solubility when included in known compositions, such as bulk liquid detergents and bulk solid detergents. The slurries can be prepared with a sufficiently high solids content to avoid leakage of the composition through an exposed end or exposed side of the cleaning article.

In example embodiments, a polymeric matrix-forming material may be utilized for forming a semi-solid intermediate layer composition with the required ability to resist leakage. As a non-limiting example, polymeric material useful as a matrix-forming materials can include ethylene oxide (EO) propylene oxide (PO) copolymers. Such a materials may include (but is not limited to) an EO-PO-EO type copolymer, which has been found useful as a polymeric surfactant that increases stabilization, compatibility, wetting and lubrication, and therefore detergency in a cleaning composition. Suitable EO-PO-EO block copolymers are commercially available under the trade name Pluronic® and may be call poloxamers. Another example embodiment of suitable matrix-forming materials include pyrrolidone-acetate copolymers, such as poly(vinylpyrrolidone-co-vinyl acetate) [PVAc-PVP] copolymers. The matrix-forming material preferably is capable of providing one or more (and preferably all) of the following functionalities; provide a vehicle for separating sensitive materials from other cleaning components; control release of components embedded in the matrix; and add detergency to the cleaning article due to surface-activities present on the matrix-forming material. Examples of “sensitive” materials include oxidizers used as bleaches, enzymes, fragrances, and buffers. Such materials may degrade, become chemically modified, or otherwise lose some or all of their intended functionalities by coming into contact with various material to which they are sensitive. The matrix-forming material(s) preferably is utilized in an amount suitable to provide an intermediate layer composition with a sufficient complex modulus, and to maintain the complex modulus at high temperatures, such as at 50° C., and as otherwise described herein. As non-limiting examples, PO-EO-PO co-polymers may be used as well as ethylene diamine that is tetrafunctionally modified with PO-EO block groups-available under the trade name Tetronic®. These types of polymer materials likewise can be suitable, in some embodiments, for use as the water soluble polymer in the solid foam structure that can be utilized as an intermediate layer.

In example embodiments, one or more suitable rheology-modifies may be utilized for forming a semi-solid intermediate layer composition with the required ability to resist leakage. Rheology-modifiers are intended to encompass material that, when added to a liquid, will reduce flowability of the liquid. As non-limiting examples, one or more hydrocolloids may be used, including, but not limited to, gelatins, pectins, agar, alginates, carageenan, cellulose derivatives (e.g., MCC, HPMC, HPC, CMC), exudate gums (e.g., gum arabic, gum tragacanth, gum karaya), gellan gum, konjac gum, modified starches, seed gums (e.g., locust bean gum, guar gum, and tara gum), and xanthan gum. The hydrocolloids preferably are utilized in an amount suitable to provide a semi-solid intermediate layer composition with a sufficient complex modulus, as otherwise described herein. Rheology modifiers may be particularly useful in intermediate layer compositions formed as gels or slurries but may also be used in compositions formed as a paste or a dough.

In one or more embodiments, an intermediate layer composition can be specifically formed as a paste. As such, a cleaning article according to the present disclosure can comprise at least one outer layer sheet and at least one intermediate layer that is configured as a paste. For example, a single outer layer sheet may be folded over with the at least one intermediate layer positioned therebetween. In some embodiments, a cleaning article according to the present disclosure can comprise a first outer layer sheet, a second outer layer sheet, and at least one intermediate layer that is configured as a paste and is positioned between the first and second outer layer sheets. The intermediate layer may comprise a plurality of compositions, and the paste may be one or more of the plurality of compositions. When a plurality of intermediate compositions are present, the plurality of intermediate compositions may be selected from any one or more of a solid foam, a gel, a slurry, a paste, or a dough.

A paste composition may include a liquid component that enables mixing of the total components to generate the paste structure. A liquid component may be an aqueous material. A liquid component may be a meltable, water soluble polymer. For example, a PEG polymer such as described herein in relation to formation of solid foams may be used as a liquid component for forming a paste. The polymer may be substantially solid at room temperature but be meltable in a relatively low temperature range, such as about 40° C. to about 80° C. The solid polymer can be mixed with the remaining components, and the mixture can be heated to melt the polymer and form the paste. The paste may then be subject to aeration to form a foam, as already described above. Remaining solid components may be, for example, solid surfactants and alkali metal salts, such as soda ash and sodium bicarbonate.

Paste compositions formed with a water soluble, meltable polymer do not necessarily need to be foamed for use. Rather, the presence of a substantially high content of components that are typically solid at room temperature allow for mixing as a paste at elevated temperature with the water soluble, meltable polymer is in flowable, liquid form. Upon cooling, however, the paste substantially hardens so that the resulting intermediate layer composition is substantially non-flowable. Again, solids may be in the form of detergent salts, such as alkali metal salts and/or in the form of surfactants that are solid at normal storage and handling temperatures, such as in the range of about 35° C. or less. Examples of surfactants available in such solid form include sodium dodecylbenzene sulfonic acid and various alcohol ethoxylates. Such compositions, however, are not limited to only solid surfactants. Rather, a relatively small content of liquid surfactants or other laundry detergent components can be utilized, such as in an amount of about 20% by weight or less, about 15% by weight or less, or about 10% by weight or less.

In some embodiments, a paste composition may be formed without the use of a water soluble, meltable polymer. Rather, the paste may achieve a suitable thickness and stability against running or creep due solely to the significantly high content of solids. The solids may be only water soluble solids, may be only water insoluble solids, or may be a mixture of water soluble and water insoluble solids. Again, surfactants and other laundry detergent components that are solid at room temperature may be utilized in the paste composition, but a content of components that are liquid at room temperature can also be included and can be useful in generating the mixability and cohesiveness needed for the paste.

A paste composition may be configured to effervesce when added to wash water. An effervescing paste can include a significant amount of alkali metal salts, such as in the range of about 30% to about 80% by weight, about 35% to about 75% by weight, or about 40% to about 70% by weight based on the total weight of the composition. Example alkali metal salts include sodium or potassium carbonate and sodium bicarbonate. Such paste composition also can include an acidic component. Such formulations preferably are prepared in a non-aqueous mixture to prevent premature reaction between the acidic and basic components. Specifically, the compositions may include less than 10% by weight, less than 5% by weight less than 2% by weight, or less than 1% by weight of water based on the total weight of the composition. The acidic component can be, for example, an organic acid, such as citric acid or malic acid. Any acid available in an anhydrous, solid form may be used. In one or more embodiments, a suitable acid may be one with a pKa of about 2.5 to about 8.0. Acid component(s) may be present in the composition in a total amount of about 2% to about 25% by weight, about 5% to about 22% by weight, or about 10% to about 20% by weight based on the total weight of the composition. When added to wash water, the laundry article with an effervescing paste intermediate layer will effervesce due to the water-induced reaction between the acidic and basic components of the intermediate layer. This causes formation of CO₂, and the gas evolution with effervescing further facilitates the degradation and dissolution of the laundry article in the wash water.

Paste compositions that are suitable for being formed without the need for increased temperature, such as to melt a water soluble binder polymer, can be particularly suitable for suspending cleaning components, such as enzymes, brighteners, and other components that are typically available in a particulate form. They thus can provide a vehicle for separating sensitive materials from other cleaning components. Examples of “sensitive” materials include oxidizers used as bleaches, enzymes, fragrances, and buffers. Such materials may degrade, become chemically modified, or otherwise lose some or all of their intended functionalities by coming into contact with various material to which they are sensitive. The use of solid components that are also detergent actives (e.g., solid surfactants, detergent builders, etc.) also provide detergency to the cleaning article and thus provide the structure required for the intermediate layer composition while still functioning as active laundry detergent components.

A semi-solid paste composition according to the present disclosure may comprise about 10% by weight or greater, about 20% by weight or greater, about 30% by weight or greater, about 40% by weight or greater, about 50% or greater, or about 60% or greater by weight of water soluble solids. In one or more embodiments, a semi-solid paste can comprise about 10% to about 85% by weight, about 25% to about 80% by weight, about 30% to about 75% by weight, or about 40% to about 70% by weight of water soluble solids. In one or more embodiments, a semi-solid paste can comprise greater than 50% by weight water soluble solids, such as in a range of about 51% to about 90% by weight, about 55% to about 85% by weight, or about 60% to about 80% by weight of water soluble solids.

A semi-solid paste composition according to the present disclosure may comprise about 5% by weight or greater, about 10% by weight or greater, about 15 by weight or greater, or about 20% by weight or greater of water insoluble solids. In one or more embodiments, a semi-solid paste can comprise about 5% to about 50% by weight, about 10% to about 45% by weight, or about 20% to about 40% by weight water insoluble solids.

A semi-solid paste composition may comprise only water soluble solids while excluding water insoluble solids. A semi-solid paste composition may comprise both water soluble solids and water insoluble solids. A semi-solid paste composition may comprise only water insoluble solids while excluding water soluble solids.

In one or more embodiments, the above solids ranges may apply to a semi-solid gel composition. In one or more embodiments, the above solids ranges may apply to a semi-solid slurry composition. In one or more embodiments, the above solids ranges may apply to a semi-solid dough composition. In one or more embodiments, the above solids ranges may apply to a composition configured to harden and form a solid intermediate layer.

In one or more embodiments, an intermediate layer composition can be specifically formed as a dough. As such, a cleaning article according to the present disclosure can comprise at least one outer layer sheet and at least one intermediate layer that is configured as a dough. For example, a single outer layer sheet may be folded over with the at least one intermediate layer positioned therebetween. In some embodiments, a cleaning article according to the present disclosure can comprise a first outer layer sheet, a second outer layer sheet, and at least one intermediate layer that is configured as a dough and is positioned between the first and second outer layer sheets. The intermediate layer may comprise a plurality of compositions, and the slurry may be one or more of the plurality of compositions. When a plurality of intermediate compositions are present, the plurality of intermediate compositions may be selected from any one or more of a solid foam, a gel, a slurry, a paste, or a dough.

A composition configured as a dough is one that is soft but thickened so that it will retain is shape and resist flowing or creep. A dough may be a particularly thick paste. A dough can be formed from any of the materials used in forming a paste and may be mixed specifically to achieve the dough-like consistency.

In some embodiments, utilizing a paste or dough formulation can partially or completely eliminate the need for rheology modifiers. This can be achieved since pastes and doughs can have a significantly higher solids concentrations providing more structure to the composition and thus reducing or eliminating the possibility for the paste or dough to creep or leak from a cleaning article using the paste or dough as an intermediate layer.

The intermediate layer of the present cleaning article can comprise at least one composition that is effective as a detergent and/or may be known for use in achieving specific cleaning functions. The intermediate layer can comprise more than one composition or filling, and it preferably comprises two or more compositions or fillings. The multiple compositions may intermingle at adjacent edges thereof; however, the multiple compositions remain as discrete compositions. The number of compositions or fillings may be indicated visually, with each composition or filling being distinctly visible through the outer layers. The number of discrete compositions used in the intermediate can be any whole number between 2 and 10. Each of the discrete compositions or fillings may have the same formulation, different formulations, or a combination thereof. In particular, one composition may be present in a single application of a defined volume, or the same composition may be repeated in multiple applications of a defined volume. Likewise, some compositions may be present singly in the intermediate, and other compositions may be present in multiple applications (i.e., repeated).

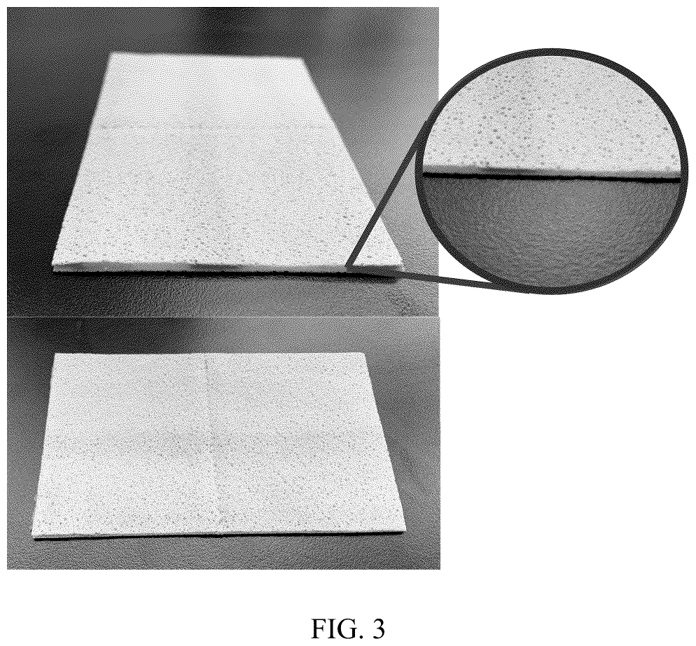

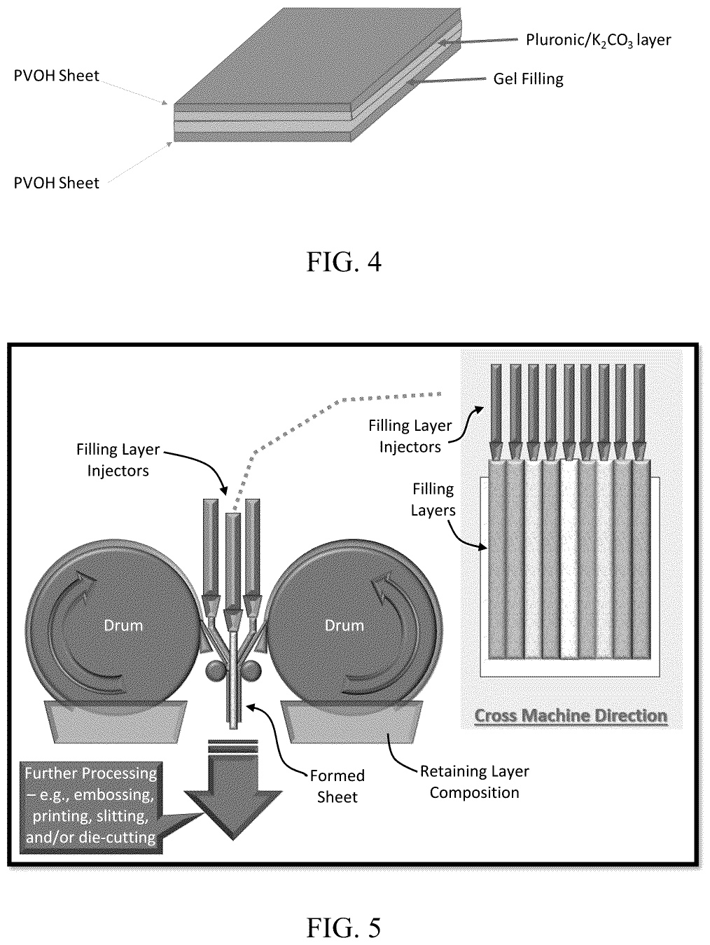

The intermediate layer compositions each can be arranged between the retaining sheets in a manner that can improve performance of the cleaning article. In some embodiments, and as shown in FIG. 3, each composition of the intermediate layer or filling is deposited perpendicular to the to the layering of the article. As such, like each of the retaining sheets, the intermediate layer compositions preferably exhibit one or both of a length or width that is greater than a thickness of the intermediate layer composition as applied to the retaining sheets. An advantage of the disclosed orientation results in a greater surface area of each detergent composition that is in contact with the surrounding atmosphere, and therefore a faster diffusion rate of the intermediate layer compositions, which directly increases the rate of dissolution of the compositions in the wash water. The intermediate layer compositions can be arranged between the outer layer sheet or sheets so as to be adjacent and substantially non-overlapping relative to one another. In other words, the intermediate layer compositions may be arranged in the same horizontal plane and may not be arranged in the same vertical plane between the one or more outer, retaining layer(s). Where multiple intermediate layer compositions are used, all of the intermediate layer compositions may be positioned in the same horizontal plane.

In one or more embodiments, a cleaning article thus can comprise a first outer layer, a second outer layer, and an intermediate layer arranged between the first outer layer and the second outer layer. Each of the outer layers may be porous and may comprise a water soluble polymer or otherwise have a configuration as provided herein. The intermediate layer can comprise at least a first segment and a second segment, the first segment being formed of a first cleaning composition and the second segment being formed of a second cleaning composition that is different from the first cleaning composition. The intermediate layer may comprise any number of segments that are arranged one or both of longitudinally and laterally across the cleaning article.

A cleaning article, and thus its layers, may have a variety of shapes but typically can be characterized in relation to sheet-like dimensions. The outer layer(s), the intermediate layer, and the overall article can have a measurable longitudinal dimension along a longitudinal axis (the direction with the greatest length), and thus has a longitudinal axis length. The longitudinal axis may be referenced as an “x” axis with an x axis length. The layers also can have a measurable lateral dimension along an axis that is perpendicular to the longitudinal axis, that is in the same plane as the longitudinal axis, and that has a length that is less than the longitudinal axis length, and thus is a lateral axis length. The lateral axis may be referenced as a “y” axis with a y axis length. If the longitudinal axis length and the lateral axis length are identical (such as with a square configuration or a round configuration), the longitudinal axis and the lateral axis are interchangeable. The layers and the article further can have a measurable thickness dimension along an orthogonal axis that is perpendicular to both the longitudinal axis and the lateral axis. The orthogonal axis may be referenced as a “z” axis with a z axis length. In embodiments where the article and its layers are elongated, the article may have a length along the x axis, a width across the y axis, and a thickness across the z axis.

Segments arranged longitudinally and/or laterally across the article or across the intermediate layer are understood to be arranged so that the segments are aligned next to one another or adjacent to one another without substantially overlapping with one another. This means that there is no measurable overlap of the segments or any overlapping portion of an individual segment is no greater than about 10%, no greater than about 5%, no greater than about 4%, no greater than about 3%, no greater than about 2%, or no greater than about 1% of the width of the individual segment. All of the segments thus are arranged substantially or completely within the same plane. Being arranged longitudinally across the article or the intermediate layer indicates that a line extending parallel to the longitudinal or x axis can cross multiple segments but a line extending parallel to the lateral or y axis or parallel to the orthogonal or z axis will not cross multiple segments. Being arranged laterally across the article or the intermediate layer indicates that a line extending parallel to the lateral axis can cross multiple segments but a line extending parallel to the longitudinal axis or parallel to the orthogonal axis will not cross multiple segments. Being arranged both longitudinally and laterally across the article or the intermediate layer indicates that a line extending parallel to the longitudinal axis and a line extending parallel to the lateral axis can cross multiple segments but a line extending parallel to the orthogonal axis will not cross multiple segments. The arrangement of segments thus can be referenced as a longitudinal array, a lateral array, or both a longitudinal array and a lateral array.

With reference to FIG. 3, the cleaning article has an intermediate layer comprising seven segments that are arranged laterally across the cleaning article. As an example of a longitudinal arrangement, the segments or stripes in the article of FIG. 3 may be arranged perpendicular to the illustrated arrangement. The article in FIG. 3 includes a perforation whereby the article may be separated into two separate and smaller sheets. Upon separating the article of FIG. 3 into two smaller sheets, the segments in each of the smaller sheets would then be arranged longitudinally across the article due to the changed dimensions of the smaller sheets relative to the larger, starting sheet.

An article having a plurality of segments arranged both laterally and longitudinally across the article may be configured so that the segments are positioned diagonally. As a further example, segments in a checkerboard pattern may be considered to be arranged both laterally and longitudinally across the article. Likewise, concentric circles would form a pattern considered to be arranged both laterally and longitudinally across the article. In each example, a line extending parallel to the longitudinal axis and a line extending parallel to the lateral axis would be capable of crossing multiple segments. Moreover, the segments need not take on only the shape illustrated in FIG. 3 (i.e., substantially straight strips). Rather, the segments may be linear or curved, may define a regular or irregular pattern of one or more shapes, or have any other arrangement that is not a stacked arrangement along the thickness of the article. While an individual intermediate layer may exclude a stacked arrangement, it is understood that other arrangements as discussed herein may be used, such as having a plurality of intermediate layers separated by one or more further retaining layers.

In various embodiments, each of the intermediate layer compositions used in the separate segments can be configured to have cleaning properties that are discrete and independent from each other or, in the alternative, that overlap in cleaning functionalities. The compositions can have various functional properties that affect the laundering objective, such as being configured specifically for cleaning or soil removal, softening, odor elimination, bleaching, or combinations thereof etc. The intermediate layer compositions can also have varied physical properties such as color, form, (i.e., gel, slurry, paste, dough, foam), diffusion rate, complex modulus, and the like.

The outer layers described herein provide cleaning articles that exhibit a unique appearance, at least partially providing visibility of the intermediate layer compositions retained between the outer layers. In various embodiments, the thickness of the outer layers, the presence of pores in the outer layers, the color of outer layers, or a combination thereof promote visibility of the intermediate layer. In some embodiments, the material of the outer layers can be transparent or translucent. In particular embodiments, the outer layers are made of a white colored, translucent material or a blue colored, translucent material. In one or more embodiments, the intermediate layer is substantially the same length and width as the outer layers, thereby extending to the side edges of the disclosed cleaning article and providing visibility of the colors of the intermediate layer at the edges of the sheet. This configuration may allow the colors of the compositions of the intermediate layer to be seen easily when looking at the sheets from an edge view. In some embodiments, the retaining sheets defining the outer layers can have a level of transparency defined by an upper level of 80%, and a lower level of 5% (e.g., 5% to 80%, 5% to 50%, 5% to 25%, 8% to 12%) and, as such, every whole number from 5 to 80 is expressly included in this disclosure (e.g. 10%) for defining upper and lower boundaries of the encompassed ranges. Likewise, the level of transparency can be “at least” any of the values within the above range or can be “less than” any of the values within the above range. Transparency can be measured using any known method such as using a transparency meter or clarity meter. Transparency can be calculated in relation to total transmittance of light through the object, which factors out any light that is absorbed or reflected, and said measurement can be calculated as: total transmittance (%)=incident light (100%)−(% absorption+% reflection). Transparency using a clarity meter can be according to ASTM standard D1746.

In some embodiments, one or more of the physical properties of the intermediate layer composition can be indicative of the functional properties of the intermediate layer compositions. Consumers often choose cleaning articles based on the specific functionalities to be provided and thus can desire visual cues that a specific functionality is present in the cleaning article chosen. Bulk cleaners (e.g., solid or liquid detergents packaged in large quantities for dosing by the consumer at the time of use) will typically have a single, uniform color that provides little indication of which functionalities are provided. Some unit dose products sold as pouches or pods may have two or three individual chambers filled with different compositions but, as already discussed above, such pouches or pods suffer from various drawbacks. The cleaning articles of the present disclosure can be provided in an overall form that are easy to use, dissolve as required in wash water, and provide the consumer with visual cues of cleaning functionalities that are easy to identify.

In some embodiments, each of the plurality of individual intermediate compositions can exhibit visually distinct colors. As noted above, certain colors can be identified with certain cleaning functionalities, and the present cleaning articles can provide the intermediate layer compositions in individual colors for rapid identification by consumers. Colors may be defined generally (e.g., blue, green, purple, white, etc.). Colors may be expressly within a defined CIELAB color space that is chosen as a unique identifier of functionality, and this is defined with the given L*a*b* values. Under this standard, L* represents perceptual lightness, with a 0 value defining black and a 100 value defining white). The a* and b* values represent chromacity with no specific numeric limits. Specifically, a* defines color ranging from green to red with negative a* values corresponding with green and positive a* values corresponding with red. Similarly, b* defines color ranging from blue to yellow with negative b* values corresponding with blue and positive b* values corresponding with yellow.

In some embodiments, an intermediate layer composition can be configured to exhibit a blue color or a green color. Such colors may be used to indicate that the intermediate layer composition is configured to provide general cleaning efficacy or be a detergent booster. A preferred blue color, for example, can be defined by L*, a*, and b* values of 64 (+/−5), −14 (+/−5), and −20 (+/−5). A preferred green color, for example, can be defined by L*, a*, b* values of 75 (+/−5), −10 (+/−5), and 8 (+/−5). In some embodiments, an intermediate layer composition can be configured to exhibit a pink color. Such color may be used to indicate that the intermediate layer composition is configured to provide softening. A preferred lighter pink color, for example, can be defined by L*, a*, b* values of 45 (+/−5), 69 (+/−5), and −17 (+/−5). A preferred darker pink color, for example, can be defined by L*, a*, b* values of 75 (+/−5), 37 (+/−5), and 4 (+/−5). In some embodiments, the intermediate layer composition can be configured to exhibit a purple color. Such color may be used to indicate that the intermediate layer composition is configured to provide odor elimination. A preferred purple color, for example, can be defined by L*, a*, and b* values of 75 (+/−5), 5 (+/−5), and −7 (+/−5). In some embodiments, the intermediate layer composition can be configured to exhibit a white color. Such color may be used to indicate that is the intermediate layer composition is configured to provide bleaching. A preferred white color, for example, can be defined by L* values ranging from 95 to 100, a* values of 0 (+/−5), and b* values of 0 (+/−5). It should be understood that the disclosed colors, objectives, and correlations are not limiting, and the individual intermediate layer compositions may have additional functionalities or even different functionalities than those noted above.

In some embodiments, the compositions of the intermediate layer are configured to be visible through one or both of the outer layers. This provides a distinct appearance that provides a visual cue to the consumer of product function when viewing in the typically largest dimensions—i.e., through the face of the outer layer sheets. To achieve the desired visual cues when viewing the intermediate layers and its segments through the outer layer(s), the compositions forming the intermediate layer segments must have a different color value than the desired end value. As noted above, the colors used for the compositions that form the segments of the intermediate layer can be defined by their L*a*b* values. As such, an individual composition forming an individual segment of an intermediate layer can be visible at an edge of the cleaning article and have a first L* value, a first a* value, and a first b* value and, when viewed through one of the outer layers can have one or more of a second L* value, a second a* value, and a second b* value that differs from the first value(s).

In one or more embodiments, a segment of an intermediate layer can have a first color defined by a first set of L*a*b* values when measured at an edge of the cleaning article where the intermediate layer is unobstructed by the first outer layer or the second outer layer and can have a second, different set of L*a*b* values when measured through one of the first outer layer and the second outer layer. For example, the L* value of the first color can be greater when measured through one of the first outer layer and the second outer layer. For example, one or both of the a* value and the b* value is less when measured through one of the first outer layer and the second outer layer.

In one or more embodiments a color of a segment of an intermediate layer can have a first L* value when viewed from an edge of the cleaning article that is not covered by an outer layer and can have a second L* value when viewed through an outer layer of the cleaning article, the second L* value being greater than the first L* value. The second L* value can be greater than the first L* value by at least 2 whole numbers, by at least 3 whole numbers, by at least 4 whole numbers, by at least 5 whole numbers, by at least 10 whole numbers, or by at least 15 whole numbers, such as up to the maximum L* value of 100. In some embodiments, the second L* value can be greater than the first L* value by about 5% to about 90%, about 10% to about 80%, about 15% to about 70%, or about 20% to about 60%. For example, as noted above, a preferred blue color can be defined by L*, a*, and b* values of 64 (+/−5), −14 (+/−5), and −20 (+/−5). As such, a first L* value of a segment (when viewed at an unobstructed edge of the article) may be 64, and a second L* value (when viewed through an overlying outer layer sheet) can be greater than 64 by a number range as noted previously.

In one or more embodiments a color of a segment of an intermediate layer can have a first a* value when viewed from an edge of the cleaning article that is not covered by an outer layer and can have a second a* value when viewed through an outer layer of the cleaning article, the second a* value being less than the first a* value. The second a* value can be less than the first a* value by an absolute value of at least 2 whole numbers, by an absolute value of at least 3 whole numbers, by an absolute value of at least 4 whole numbers, by an absolute value of at least 5 whole numbers, by an absolute value of at least 10 whole numbers, or by an absolute value of at least 15 whole numbers, such as up to the outer positive and negative boundaries for a* values. In some embodiments, the second a* value can be less than the first a* value by about 5% to about 90%, about 10% to about 80%, about 15% to about 70%, or about 20% to about 60%. For example, as noted above, a preferred blue color can be defined by L*, a*, and b* values of 64 (+/−5), −14 (+/−5), and −20 (+/−5). As such, a first a* value of a segment (when viewed at an unobstructed edge of the article) may be −14, and a second a* value (when viewed through an overlying outer layer sheet) can be less than-14 by a number range as noted previously.

In one or more embodiments a color of a segment of an intermediate layer can have a first b* value when viewed from an edge of the cleaning article that is not covered by an outer layer and can have a second b* value when viewed through an outer layer of the cleaning article, the second b* value being less than the first b* value. The second b* value can be less than the first b* value by an absolute value of at least 2 whole numbers, by an absolute value of at least 3 whole numbers, by an absolute value of at least 4 whole numbers, by an absolute value of at least 5 whole numbers, by an absolute value of at least 10 whole numbers, or by an absolute value of at least 15 whole numbers, such as up to the outer positive and negative boundaries for b* values. In some embodiments, the second b* value can be less than the first b* value by about 5% to about 90%, about 10% to about 80%, about 15% to about 70%, or about 20% to about 60%. For example, as noted above, a preferred blue color can be defined by L*, a*, and b* values of 64 (+/−5), −14 (+/−5), and −20 (+/−5). As such, a first b* value of a segment (when viewed at an unobstructed edge of the article) may be −20, and a second b* value (when viewed through an overlying outer layer sheet) can be less than −20 by a number range as noted previously.

In some embodiments, a plurality of individual filling compositions of the intermediate layer are deposited to form a pattern visible through one or both of the outer layers. While the pattern design is not limited, in some embodiments, and as shown in FIG. 3, the pattern can be striped. The striping may be a repeating arrangement (e.g., the stripes in FIG. 3), or may be a non-repeating pattern. In some embodiments, the pattern may be non-repeating (e.g., other sequences of striping, waves, spirals, marbled, something artistic or representative of a company logo, trademark, or the like). In some embodiments, a striped pattern can be defined such that a stripe of a specified color is not immediately adjacent to another stripe of the same, specified color. Similarly, a striped pattern can be defined such that any two strips of the same, specified color is separated by at least one strip of a different, specified color. Compositions of different colors likewise may be present as a plurality of squares, circles, triangles, or other shapes filling part or all of the area of a retaining sheet to form the intermediate layer between two outer layers. Stripes may be substantially linear. Stripes may be substantially non-linear. Non-linear stripes may be curved to define a wave structure that may be a uniform wave where peaks and valleys are uniformly spaced or may be a non-uniform wave where peaks and valleys are non-uniformly spaced.

Individual intermediate layer compositions may be labeled in relation to the desired functionality. Accordingly, the individual intermediate layer compositions may be separately referenced as, for example, an intermediate layer cleaning composition, an intermediate layer odor elimination composition, an intermediate layer softening composition, an intermediate layer bleaching composition, an intermediate layer enzymatic composition, an intermediate layer booster composition, or the like. Such terminology can define a primary function of the individual composition, but it is understood that the individual compositions may still include other cleaning components otherwise disclosed herein.

The intermediate layer compositions may, individually, have the same dissolution rate or different dissolution rates. For example, it can be desirable for intermediate layer cleaning compositions to be available early in a wash cycle so that the components of the cleaning composition can work on the items being laundered for a longer period of the wash cycle. On the other hand, it can be desirable for intermediate layer softening compositions to be available later in a wash cycle, or even in a rinse cycle in an automatic washing machine so that laundered items can achieve maximum softness late in the washing cycle to be retained by the laundered items. Accordingly, a cleaning article according to the present disclosure can be configured so that an intermediate layer cleaning composition will dissolve from the cleaning article faster than an intermediate layer softening composition. Likewise, any one or more of the individual intermediate layer compositions can be configured with individualized and different dissolution rates.

In one or more embodiments, the intermediate layer compositions may be present in sheet-like arrangements between the outer layers. In other words, the intermediate layer can comprise two or more layers positioned in a side-by-side arrangement between the first outer layer and the second outer layer, each of the two or more intermediate layers being configured to provide a different cleaning functionality. Such orientation of the intermediate layer compositions may be effective to provide for controlled release of certain components of the intermediate layer compositions. Each intermediate layer composition may have substantially the same thickness.

As previously noted above, cleaning articles of the present disclosure comprise two outer layers (i.e., retaining sheets) and one or more intermediate layers each formed of a plurality of intermediate layer compositions (i.e., filler compositions), and, optionally, one or more divider layers or sheets. This arrangement is advantageous since it provides multiple positions for providing multiple cleaning agent components (e.g., any components commonly found in laundry care compositions) in a wide number of variations to provide a number of benefits. The outer layers can be configured solely as carriers and may contain no components with an intentional cleaning functionality. Beneficially, however one or both of the first outer layer and the second outer layer can be configured to include one or more cleaning components embedded therein. Since the outer layers are configured for handling by consumers, any cleaning components present in or on the outer layer(s) preferably have little to no skin irritation associated with handling thereof. For example, one or both of the outer layers may include one or more surfactants useful to remove soils, stains, and the like from fabrics. The outer layers preferably include “mild” surfactants that provide cleaning efficacy but that are not sufficiently strong to be an irritant to contacted skin. Alkali agents, enzymes, and other materials that could irritate skin are safely isolated from consumer contact within the intermediate layer compositions. Other cleaning components as described herein may be included in the outer layers as an alternative to, or in addition to, one or more surfactants.

In some embodiments, the outer layer components particularly may be prepared using typical polymer composition manufacturing methods that include forming a melt composition that is then cast, molded, extruded, etc. into the desired end form. Alternatively, the outer layer sheets may be defined substantially as a fabric formed of fibers of polymer that have been melt-extruded and either laid in a non-woven format or gathered and used for forming a woven sheet. The intermediate layer compositions can be prepared with alternative methods (e.g., simple mixing to form pastes or slurries or gels) that do not include significant heating that can be damaging to sensitive materials in the cleaning compositions (e.g., enzymes). Given that several, different filling compositions can be used in the intermediate layer, this provides the ability to prepare a number of different cleaning articles with desired combinations of cleaning components.

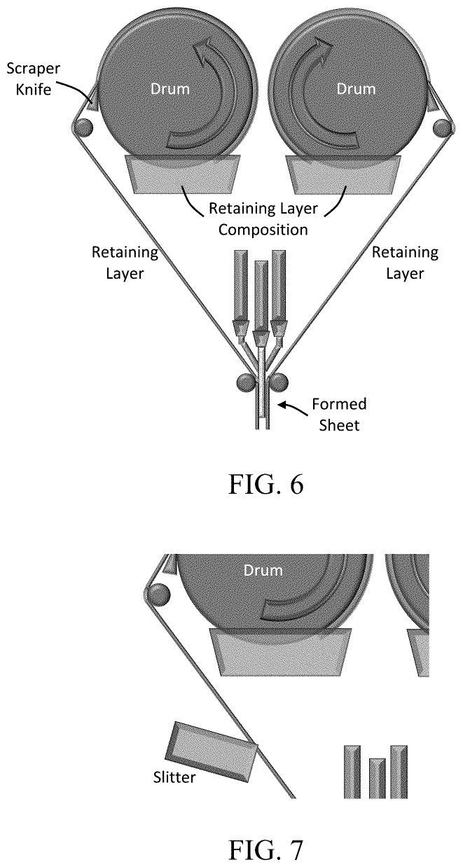

In one or more embodiments, the present disclosure also encompasses methods of making a laundry detergent article with improved properties, as disclosed herein. The method can begin with forming the water soluble material. In one or more embodiments, a water soluble material, such as PVOH, is provided in a slurry form. The slurry can be placed in a pan under a rotating drum, where the drum skims the surface of the pan and forms a thin layer of slurry on the surface of the drum. The rotary drum is then heated from within, forcing moisture out of the thin layer of slurry, and drying the layer. The layer is then removed from the surface with a scraper knife and manipulated with idle rollers to form a foam sheet and rolled for further processing. In one or more embodiments, and as shown in FIG. 5, dual rotating drums are provided, each rotating inwards and forming sheets of the water soluble material. While this is the commercially obvious and preferred orientation to create a layered product, It ultimately creates an inferior product as explained later. In one or more embodiments, and as shown in FIG. 6, dual rotating drums are provided, each rotating outwards and forming sheets of the water soluble material. As discussed below, choice of drum rotation can affect one or more features of the formed product, and using outwardly rotating drums can result in superior products with preferred features and functionalities not seen when prepared with the inwardly rotating direction. The rotation direction (i.e., inwards in FIG. 5, and outwards in FIG. 6) can, for example, affect the appearance and texture of each sheet. As the moisture is forced out of the layer of slurry, the moisture migrates in the direction of the drum outwards causing bubbles, or pores, to form in the layer as it dries. In embodiments such as FIG. 5, for example, the inwards rotation of the drum causes the sheet to have pores migrating in the direction of the outer surface to the inner surface. As a result, the outer surface of the sheets may exhibit a smoother texture and shinier appearance than the inner surface of the sheet, and the inner surface of the sheet may exhibit increased porosity than the outer surface of the sheet. Conversely, in embodiments such as FIG. 6, for example, the outwards rotation of the drum causes the sheet to have pores migrating in the direction of the inner surface to the outer surface. As a result, the inner surface of the sheet may exhibit a smoother texture and shinier appearance than the outer surface of the sheet, and the outer surface of the sheet may exhibit increased porosity than the inner surface of the sheet. In various studies, consumers have indicated a preference towards handling a laundry detergent article as disclosed herein with a porous outer layer rather than a smooth outer layer. In particular, the increased grip that the porous surface provides was considered desirable. Additionally, the porous outer layer further accentuates the intermediate layer, which conveys to the consumer that the article will undergo rapid dissolution.

In one or more embodiments, and as shown in FIG. 7, slitting equipment may be provided after the layer of dried slurry is removed from the rotary drum with the scrapper knife. The sheets of water soluble material may be slit and cut into desired dimensions prior to being filled.

In one or more embodiments, the sheets are rolled and oriented to form a first side of the laundry detergent article and a second side of a laundry detergent article. A detergent formulation is deposited and filled between the first side and the second side. In various embodiments, and as shown in FIG. 5, the detergent formulation comprises multiple compositions. Each composition may be deposited separately and simultaneously between the rolled sheets. In some embodiments, the detergent compositions are cooled and pressed, thus forming the detergent formulation, and then deposited between the rolled sheets. The sheets and filled detergent formulation may then be pressed, thus affixing the first side and the second side to the detergent formulation and forming laundry detergent articles. In various embodiments, the laundry detergent articles are further processed with embossing, printing, slitting, and/or dic-cutting.

As previously noted, the cleaning components used in the presently disclosed cleaning articles can encompass a wide variety of materials that are useful in the laundering of fabrics and, more specifically, clothing items. Surfactants and builders in particularly are commonly used in laundry detergents and may be used in the present compositions as well.

A wide variety of anionic surfactants and/or nonionic may be used according to the present disclosure. In various embodiments, a suitable anionic surfactant may include one or more salts (e.g., sodium, potassium, ammonium, and substituted ammonium salts such as mono-, di- and triethanolamine salts) of anionic sulfates, sulfonates, carboxylates, and sarcosinates. Exemplary anionic sulfates can include linear and/or branched primary and secondary alkyl sulfates, alkyl ethoxysulfates, fatty oleoyl glycerol sulfates, alkyl phenol ethylene oxide ether sulfates, C₅-C₁₇ acyl-N-(C₁-C₄ alkyl) and -N-(C₁-C₂ hydroxyalkyl) glucamine sulfates, and sulfates of alkylpolysaccharides, such as alkylpolyglucoside sulfates. Exemplary alkyl sulfates can include linear and branched primary C₁₀-C₁₈ alkyl sulfates. Exemplary alkyl ethoxysulfate surfactants can include C₁₀-C₁₈ alkyl sulfates that have been ethoxylated with from 0.5 to 20 moles of ethylene oxide per molecule. Exemplary anionic sulfonate surfactants can include salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof. Exemplary anionic carboxylates can include alkyl ethoxy carboxylates, and alkyl polyethoxy polycarboxylates. In some embodiments, preferred anionic surfactants can include various sulfates (e.g., alkyl ether sulfates, such as laureth sulfate salts), alkyl ester sulfonates, and alkylbenzene sulfonate (e.g., C₅ to C₂₀ or C₁₀ to C₁₆). Non-limiting examples of anionic surfactants that may be used herein include sodium laureth sulfate (SLES), sodium lauryl sulfate (SLS), methyl ester sulfonate (MES), and sodium C₁₀₋₁₆ alkylbenzene sulfonate (LAS). In certain embodiments, ethoxylated anionic surfactants may be utilized and may comprise a limited number of moles of ethylene oxide groups. For example, an alkyl ether sulfate anionic surfactant may comprise less than 5 moles, or less than 4 moles of ethylene oxide groups, such as 1 to 4 or 2 to 3 ethylene oxide groups.

In various embodiments, a suitable nonionic surfactant may include alkyl ethoxylate condensation products of aliphatic alcohols with from 1 to 25 moles of ethylene oxide wherein the alkyl chain of the aliphatic alcohol can either be straight or branched, primary or secondary, and generally contains from 6 to 22 carbon atoms. Further suitable nonionic surfactants can include water soluble ethoxylated C₆-C₁₈ fatty alcohols and C₆-C₁₈ mixed ethoxylated/propoxylated fatty alcohols. For example, the ethoxylated fatty alcohols can be C₁₀-C₁₈ ethoxylated fatty alcohols with a degree of ethoxylation of from 3 to 20. In some embodiments, mixed ethoxylated/propoxylated fatty alcohols can have an alkyl chain length of from 10 to 18 carbon atoms, a degree of ethoxylation of from 3 to 30, and a degree of propoxylation of from 1 to 10. In further embodiments, suitable nonionic surfactants can include those formed from the condensation of ethylene oxide with a hydrophobic base formed by the condensation of propylene oxide with propylene glycol. Examples of compounds of this type include certain of the commercially-available Pluronic™ surfactants, marketed by BASF. Further, suitable nonionic surfactants can include those formed from the condensation of ethylene oxide with the product resulting from the reaction of propylene oxide and ethylenediamine. Examples of this type of nonionic surfactant include certain of the commercially available Tetronic™ compounds, marketed by BASF. In certain embodiments, suitable nonionic surfactants can be selected, for example, from various alcohol ethoxylates. In some embodiments, the nonionic surfactant can be defined in relation to the alcohol chain length and/or the number of ethoxylate groups present in the molecule. For example, the nonionic surfactant can comprise an alcohol ethoxylate formed from an alcohol with a carbon chain length of 3 to 20 carbon atoms, 5 to 20 carbon atoms, 7 to 19 carbon atoms, 9 to 18 carbon atoms, 10 to 17 carbon atoms, or 12 to 15 carbon atoms. As a further example, the nonionic surfactant can comprise an alcohol ethoxylate having 2 to 10, 4 to 9, or 6 to 8 moles of ethylene oxide per mole of alcohol. Non-limiting examples of nonionic surfactants that may be used herein include ethoxylated alcohols (AE) (C₁₂₋₁₅ alcohols, in particular), such as those available under the tradename NEODOL®, lauryl or myristyl glucosides (APG), and polyoxyethylene alkylethers (2° AE).

Suitable builders can include materials that are effective as alkalinizing agents. For example, various alkali carbonates and/or other inorganic alkalinizing agents may be utilized to increase the pH of the laundry detergent composition while simultaneously increasing the viscosity to a desired level. Preferably, sodium and/or potassium salts (e.g., K₂CO₃ and/or Na₂CO₃) may be used. For example, soda ash can be used. In some embodiments, one or more components may be utilized for formation of a carbonate in situ. For example, bicarbonates and hydroxides in combination can be effective for in situ formation of a carbonate. In an example embodiment, sodium bicarbonate and sodium hydroxide may be utilized for this purpose, and other forms of bicarbonates and hydroxides may likewise be utilized.

The cleaning articles of the present disclosure also can include any number of additional components recognized as useful in cleaning articles, such as laundry detergents. As non-limiting examples, any one or more of the following materials may be included in any of the various compositions of the present disclosure: betaine and amino-oxide type surfactants, enzyme(s), enzyme stabilizer(s), dye(s), optical brightener(s), antiredeposition polymer(s), fluorescent whitening agent(s), fragrance(s), bittering agent(s), thickener(s), antifoaming agent(s), pH adjustor(s), salt(s), bleach(es), fabric softener(s), pearl luster agent(s), preservative(s), laundry booster(s), formulation aids (e.g. alcohols, polyols, sugars), etc. In one or more embodiments, an intermediate layer composition according to the present disclosure can include any one or more of the following components in any combinations thereof: Pluronic® F127 (polyol surfactant); propylene glycol, Neodol® 25-7 (alcohol ethoxylates); Laponite RDS; PVAc-PVP copolymer; Sodium Dodecyl Sulfate; glycerin; Kelzan® AP-AS (Xanthan Gum); Acusol™ 445N (acrylic acid homopolymer); Trilon® M; MgCl₂; Neodol® 25-9; Brij 56 (C16E10 nonionic); Steol® 25-3S/70FC [70% aqueous solution of Na-salt of C₁₂₋₁₅ (EO)₃ sulfate]; Mirataine® O-30 (30% oleoamidopropyl betaine); Pluronic P123; Na₄EDTA; MEA (monocthanolamine); BIOSOFT® S-118 (linear alkylbenzene (11.8) sulfonic acid); STEOL® OS-370 Plus (linear fatty alcohol ether sulfate); TRILON® C (diethylenetriaminepentaacetate pentasodium); PKFA (palm kernel fatty acids); ACTICIDE® MBS; sodium bicarbonate; citric acid; malic acid; Nacconol® 90 G (dodecyl benzene sulfonic acid, sodium salt); Stepanol® ME-DRY (sodium lauryl sulfate powder); Carbowax PEG 600; Pluronic® F-77 (nonionic block copolymer surfactant); Bioterge® AS-90 (Anionic C14-16 olefin sulfonate); sodium starch glycolate; Carbowax PEG 8000; PEG 600; Aerosil® R 816 (fumed silica after-treated with hexadecylsilane); Aerosil® 150 (fumed silica with specific surface area of 150 m²/g); and Aerosil® 300 (fumed silica with specific surface area of 300 m²/g).

### EXPERIMENTAL

### Example 1

A series of samples using ethylene oxide (EO) propylene oxide (PO) copolymers, specifically those of the EO-PO-EO type, were formulated. These polymers have unique properties since they display surface active behavior in addition to polymeric properties. These EO-PO-EO block copolymers are commercially available from BASF under the trade name Pluronic® and are also referred to generically as poloxamer surfactants. The layered silicate Laponite RDS was also used. Three sample compositions are shown below in TABLE 1.

TABLE 1

| | 5632- | 5632- | 5632- |
|---|---|---|---|
| Component | 105-3 (Wt. %) | 105-4 (Wt. %) | 105-5 (Wt. %) |
| Pluronic F127 | 28.3 | 28.3 | 25.9 |
| Propylene glycol | | 9.4 | 9.4 |
| Neodol ® 25-7 | | | 4.7 |
| Laponite RDS | 5.7 | 5.7 | 5.7 |
| Water | 66.0 | 56.6 | 54.2 |

Compositions were also prepared using a poly(vinylpyrrolidone-co-vinyl acetate) [PVAc-PVP] copolymer (MW=MW of 50,000 g/mole and a VAc/VP ratio of 1.3). Four sample compositions are shown below in TABLE 2.

TABLE 2

| | 5632- | 5632- | 5632- | 5632- |
|---|---|---|---|---|
| | 111-1 | 111-2 | 111-3 | 111-4 |
| Component | (Wt. %) | (Wt. %) | (Wt. %) | (Wt. %) |
| Pluronic F127 | 20.0 | 20.0 | 20.0 | 20.0 |
| PVAc-PVP copolymer | 10.0 | 10.0 | 10.0 | 10.0 |
| Propylene glycol | | 10.0 | 5.0 | 3.5 |
| Neodol ® 25-7 | | | 5.0 | 2.5 |
| Sodium Dodecyl | | | | 2.5 |
| Sulfate | | | | |
| MgCl₂ | | | | 1.5 |
| Water | 70.0 | 60.0 | 60.0 | 60.0 |

Samples were prepared by applying approximately 1 g of filling between two PVOH sheets of dimensions 125 mm (length)×50 mm (width)×0.8 mm (thick). The assemblages were then passed through a nip roller to distribute the filling between the outer sheets.

The assemblages were set aside for up to 1 week at RT and observed for filling bleeding through the outer sheets. Shown below in TABLE 3 are observations for each assemblage employing the different fillings, along with G* values measured for each.

TABLE 3

| Sample 5632- | Observation | G* (Pa) (σ = 10 Pa) |
|---|---|---|
| 105-3 | No bleed through | 24460 |
| 105-4 | No bleed through | 29370 |
| 105-5 | No bleed through | 16250 |
| 111-1 | Slight bleed | 4794 |
| 111-2 | Slight bleed | 3339 |
| 111-3 | Moderate bleed | 3010 |
| 111-4 | Moderate bleed | 66.3 |

The data is indicative that a minimum complex modulus in range of about 5000 to 15000 Pa is preferred to prevent the filling from flowing out and/or bleeding through the outer sheets. The compositions were additionally assessed for dissolution time. A sample of 4 g (sheets+filling) was added to 1 L of water (in a 2 L beaker) stirred with a 2 inch diameter impeller rotating at 700 rom. The water temperature was 10° C. Observations are shown below in TABLE 4. The data suggests that the magnitude of G* may have some influence on dissolution time, but may not be the only factor driving dissolution.

TABLE 4

| Sample 5632- | Observation |
|---|---|
| 105-3 | Not fully dissolved at 10 minutes |
| 105-4 | Not fully dissolved at 10 minutes |
| 105-5 | Fully dissolved at about 10 minutes |
| 111-1 | Dissolved in about 7.5 minutes |
| 111-2 | Dissolved in about 6 minutes |
| 111-3 | Dissolved in about 8 minutes |
| 111-4 | Dissolved in about 7.5 minutes |

### Example 2

Compositions employing polysaccharides such as xanthan gum can also be employed as fillings. The following example compositions as shown in TABLE 5 are presented. Observations on filling stability and dissolution time are also noted. It should be noted that leakage was reduced by decreasing the water content, likely decreasing the level of interaction with the sheet.

TABLE 5

| | 5515-133-4 | 5515-133-5 | 5632-128-3 | 5632-128-4 |
|---|---|---|---|---|
| Ingredients | (Wt. %) | (Wt. %) | (Wt. %) | (Wt. %) |
| Water | 87 | 87 | 35.00 | 35.00 |
| Glycerin | | | 40.00 | 40.00 |
| Kelzan ® AP-AS (Xanthan | 2.00 | 2.00 | 2.00 | 2.00 |
| Gum) | | | | |
| Acusol ™ 445N (45% active) | | | 1.00 | 1.00 |
| Trilon ® M (40% active) | | | 3.00 | 3.00 |
| MgCl₂ | 5.00 | 5.00 | 6.00 | 6.00 |
| Neodol ® 25-9 | | 6.00 | | |
| Neodol ® 25-7 | 4.00 | | | |
| Brij 56 (C16E10 nonionic) | | | | 10.00 |
| Steol ® 25-3S/70FC | 2.00 | | 4.00 | 3.00 |
| [70% aqueous solution of Na- | | | | |
| salt of C₁₂₋₁₅(EO)₃ sulfate] | | | | |
| Mirataine ® O-30 (30% | | | 9.00 | |
| oleoamidopropyl betaine) | | | | |
| Filling stability | Leakage | Leakage | No | Slight |
| | through sheets | through sheets | leakage | leakage |
| Dissolution time (min) | 6.5 | 5.75 | 6.5 | 5.75 |

### Example 3

Compositions employing various fillings placed between two PVOH sheets were assembled and tested for cleaning efficacy in a wash study. Flags containing a range of test stains and soils were washed in top-load washers (capacity=70 L), under conditions of 120 ppm (as CaCO₃) water hardness and temperature at 86° F. Percent stain removal (% SR) values were assessed using an imaging technique and measuring L*, a*, and b* parameters in the in the CIE L*a*b* color space. Values of AE, a root mean square color difference between the swatch and a non-soiled standard swatch, were calculated for unwashed and washed swatches according to:

Before washing:

$$Δ {E}_{u} = {[ {( {L}_{u} - {L}_{o} )}^{2} + {( {a}_{u} - {a}_{o} )}^{2} + {( {b}_{u} - {b}_{o} )}^{2} ]}^{1 / 2} \qquad [ 1 ]$$

After washing:

$$Δ {E}_{w} = {[ {( {L}_{w} - {L}_{o} )}^{2} + {( {a}_{w} - {a}_{o} )}^{2} + {( {b}_{w} - {b}_{o} )}^{2} ]}^{1 / 2} \qquad [ 2 ]$$

where u, w, and o correspond to values for unwashed swatch, washed swatches, and non-stained swatches, respectively. The % stain removal (% SR) was then calculated according to:

$$\% SR = [ ( Δ {E}_{u} - Δ {E}_{w} ) / Δ {E}_{u} ] \times 100 \qquad [ 3 ]$$

The wash study evaluated efficacies of samples employing compositions described in Examples 1 and 2, as well as the following composition shown in TABLE 6.

TABLE 6

| Component | 5632-119-1 (Wt. %) |
|---|---|
| Pluronic F127 | 17.293 |
| PVAc-PVP copolymer | 8.647 |
| Propylene glycol | 9.43 |
| Neodol 25-7 | 4.72 |
| Laponite RDS | 5.66 |
| Water | 54.25 |

PVOH sheet-filling assemblies were constructed using PVOH-based laundry sheets commercially available under the brand name Breezeo™ (referenced in TABLE 7 as sheet “A”). The sheets were cut to sizes weighing 2.5 g each, and 1 g of filling composition was placed between two of the 2.5 g sheets for form a test article. A control set of the “A” sheets (total ˜5 g) was also run. Wash results are provided below in TABLE 7, which provides cleaning efficacy in terms of sum total percentage of stain/soil removal (% SR). The various samples were tested on fabrics made of woven cotton or polyester/cotton 65/35 soiled with a variety of agents, including blood, olive oil, chocolate ice cream, dirty motor oil, blueberry, gravy, dust, sebum, grape juice, mustard, wine, spaghetti sauce, tea, coffee, coffee with milk, grass, makeup, clay, chocolate syrup, beef tallow, meat drippings, burnt butter, and blue ball point ink. The wash data indicates that the experimental samples generally performed better than the sheets alone.

TABLE 7

| Laundry Article ID | System | Total % SR |
|---|---|---|
| A | Sheet only (5 g) | 1813 |
| B | Sheet (5 g) + 5632-105-5 (1 g) | 1867 |
| C | Sheet (5 g) + 5632-119-1 (1 g) | 1835 |
| D | Sheet (5 g) + 5515-133-4 (1 g) | 1837 |
| E | Sheet (5 g) + 5515-133-5 (1 g) | 1868 |

### Example 4

A second wash study was carried out. The formulas evaluated are presented in TABLE 8 below. Formulas 128-3 and 128-4 from Example 2 were also included.

TABLE 8

| Component | 5632-128-1 (Wt. %) | 5632-128-2 (Wt. %) |
|---|---|---|
| Pluronic F127 | 17.293 | |
| Pluronic P123 | | 17.293 |
| PVAc-PVP copolymer | 7.657 | 7.657 |
| Propylene glycol | 9.43 | 9.43 |
| Neodol 25-7 | 4.72 | 4.72 |
| Laponite RDS | 3.77 | 3.77 |
| Acusol 445N | 2.20 | 2.20 |
| (45% active | | |
| Na-polyacrylate) | | |
| Na₄EDTA | 1.00 | 1.00 |
| Water | 53.93 | 53.93 |

The laundry articles were prepared using the commercially available sheets as described in Example 3. Before application of composition 128-1, composition 128-2, composition 128-3, or composition 128-4 to the sheets, 0.2% by weight of a mannanase enzyme and 0.8% by weight of a protease enzyme were added to the filling compositions. The various samples were tested on fabrics made of woven cotton or polyester/cotton 65/35 soiled with a variety of agents, including blood, olive oil, chocolate ice cream, dirty motor oil, blueberry, gravy, dust, sebum, grape juice, mustard, wine, spaghetti sauce, tea, coffee, coffee with milk, grass, makeup, clay, chocolate syrup, beef tallow, meat drippings, burnt butter, and blue ball point ink. Wash results are reported below in TABLE 9.

TABLE 9

| Laundry Article ID | System | Total % SR |
|---|---|---|
| A | Sheet only (4 g) | 1457 |
| B | Sheet (4 g) + 5632-128-1 (1 g) | 1518 |
| C | Sheet (4 g) + 5632-128-2 (1 g) | 1568 |
| D | Sheet (4 g) + 5632-128-3 (1 g) | 1494 |
| E | Sheet (4 g) + 5632-128-4 (1 g) | 1520 |

The results indicate that addition of the filling component improved wash performance over sheets alone. It can also be seen how changing the structuring polymer (and in these examples a surfactant as well) from F127 to P123 improved overall detergency. In TABLE 10 below, surfactant properties of each polymer are compared.

TABLE 10

| | | % Hydrophile (by weight) | |
|---|---|---|---|
| Polymer | MW | (polyoxyethylene) | HLB |
| F127 | 12600 | 71 | 22 |
| P108 | 5750 | 36 | 8 |

It is preferred that the weight percent of hydrophile in the structuring be greater than about 30%. Among the xanthan-based fillings (128-3 and 128-4), it can be seen that employment of the Brij (nonionic) surfactant over the betaine surfactant improved performance, although it is noted that 128-4 had a higher surfactant level compared to 128-3 (12.1% in 128-4 compared with 5.8% in 128-3).

### Example 5

In this example, results are shown where the degree of dissolution of a the Pluronic/K₂CO₃ layer is determined by the type of Pluronic. Mixtures of K₂CO₃ and Pluronic were prepared as indicated in TABLE 11 below, with the ratio of the two Pluronics varied.

TABLE 11

| Sample | Wt. % Pluronic | Wt. % Pluronic | |
|---|---|---|---|
| 5632- | F127 | P123 | Wt. % K₂CO₃ |
| 141-4 | 35.70 | 0 | 64.3 |
| 141-6 | 17.85 | 17.85 | 64.3 |
| 142-1 | 6.80 | 29.00 | 64.3 |
| 141-5 | 0 | 35.70 | 64.3 |

The compositions were prepared by placing both Pluronics in a beaker, heating in a microwave oven to about 70° C., and then adding K₂CO₃ while stirring. The molten slurry was then place in a silicone mold to form solids of about 2.5 cm×3.7 cm×0.3 cm.

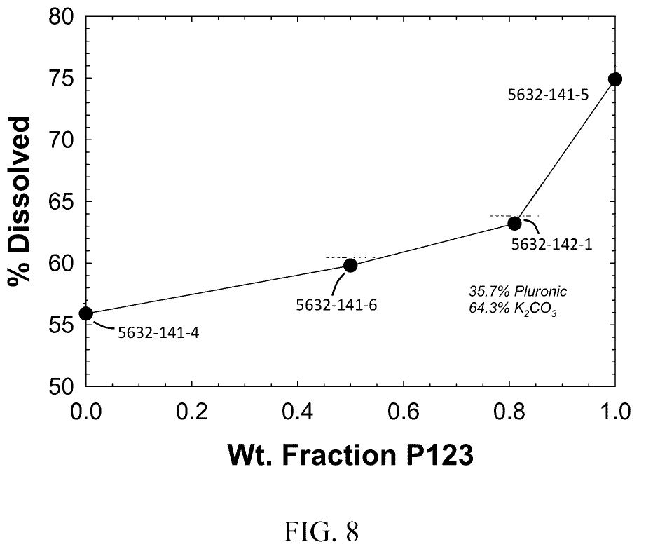

Dissolution studies were performed by placing one the Pluronic/K₂CO₃ bars into 1.0 L of water, in a 1.5 L beaker. The water was stirred with a 3″ diameter radial impeller rotating at 250 rpm. The sample was weighed before and after a 10-minute period of dissolution testing. Shown below are measurements of percent dissolved plotted versus the weight fraction (based on Pluronic only) of P123. The result data is reproduced in FIG. 8. These results indicate that increasing the level of P123 increased the degree of dissolution.

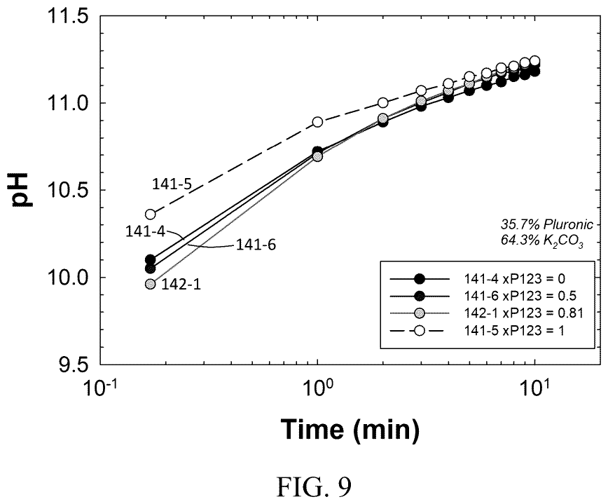

Also assessed in the dissolution studies was pH versus time. The result data is reproduced in FIG. 9. The data show that not only did increasing the proportion of P123 increase the initial pH and pH throughout much of the experiment, but incorporation of the K₂CO₃ into the Pluronic matrix allowed for a controlled release of the buffer. Such a controlled release mechanism can also be applied to other actives such as oxidizers (bleaches), enzymes, bluing agents, fragrances etc.

### Example 6

In this example, data is presented showing the effect of varying the level of K₂CO₃. The following compositions shown in TABLE 12 were prepared. It should be noted that the weight fraction of P123 was kept at 0.81.

TABLE 12

| Sample | Wt. % Pluronic | Wt. % Pluronic | |
|---|---|---|---|
| 5632- | F127 | P123 | Wt. % K₂CO₃ |
| 142-1 | 6.80 | 28.90 | 64.30 |
| 142-2 | 6.04 | 25.76 | 68.20 |
| 143-3 | 5.22 | 22.28 | 72.50 |
| 143-4 | 4.60 | 19.60 | 75.80 |

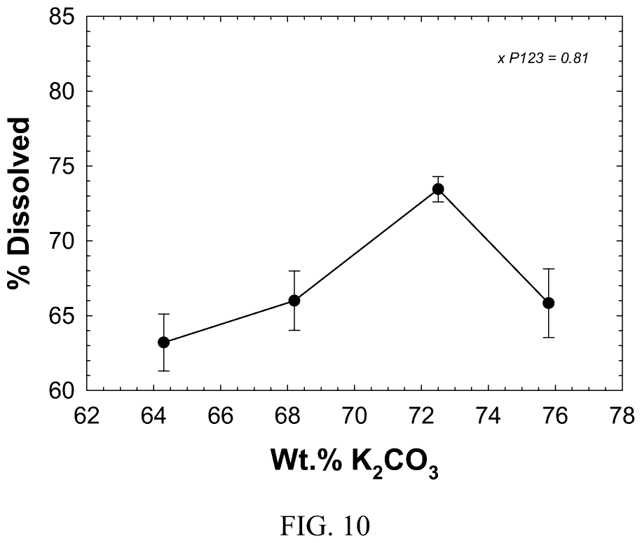

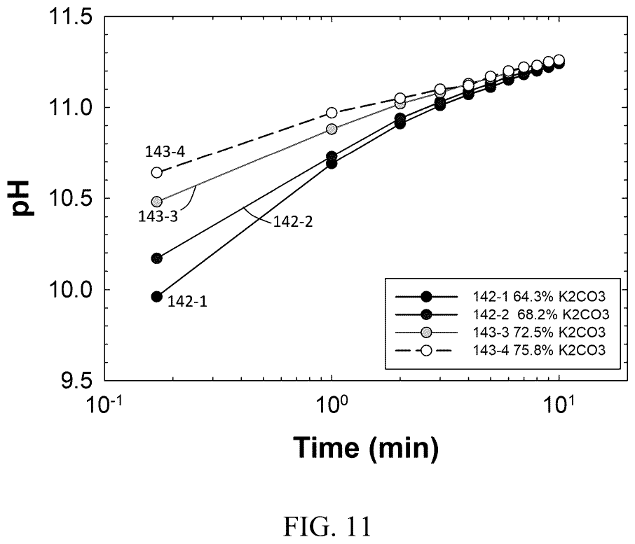

Samples were prepared as described above. Dissolution data is reproduced in FIG. 10, with amount of dissolution plotted versus the level of K₂CO₃ in the sample. It is particularly interesting that an optimal point may exist around 73.5% K₂CO₃. The reason is unclear at this point, but may be due to the presence of an optimal levels of components in order to provide a structure that has enough soluble salt, but is disperse enough that the salt is not compacted with itself. The pH data of the samples is reproduced in FIG. 11, with values of pH plotted versus time. As indicated by these results, increasing the level of K₂CO₃ generally increased pH throughout the experiment.

### Example 7

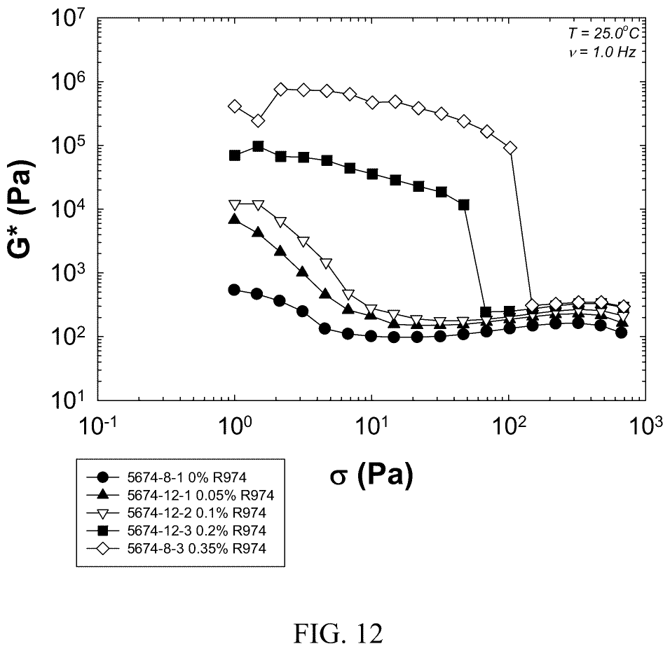

Several slurry compositions were prepared and evaluated for their rheological properties. The compositions are shown in TABLE 13. Rheological data for each of the slurries are shown in FIG. 12 and illustrates how slurry modulus may be increase with addition of the Aerosil R974 fumed silica. Among these compositions, those having Aerosil levels greater than or equal to 0.2% would be most preferred for intermediate layers.

TABLE 13

| Sample 5674- | Wt % Poloxamer 184 | Wt % Aerosil R974 | Wt % K2CO3 |
|---|---|---|---|
| 8-1 | 35.0 | 0 | 65 |
| 12-1 | 34.95 | 0.05 | 65 |
| 12-2 | 34.9 | 0.1 | 65 |
| 12-3 | 34.8 | 0.2 | 65 |
| 8-3 | 34.7 | 0.35 | 65 |

### Example 8

Various combinations of water soluble polymers and concentrated detergent compositions were evaluated for usefulness in forming a substantially solid foam structure that may be used in a cleaning article, and particularly as an intermediate layer positioned between one or more outer sheets. Testing was done to determine mixture suitability to form foams that exhibit reduced leakage from the cleaning article while still providing desired dissolution times.

The same, concentrated detergent base was used for each mixture. The detergent base formulation is shown in TABLE 14. Said detergent was mixed with different levels and grades of PEG, as further described below.

TABLE 14

| Detergent Component | Weight Percentage (%) |
|---|---|
| NEODOL ® 25-7 (alcohol ethoxylates) | 11.3% |
| MEA (monoethanolamine) | 11.3% |
| BIOSOFT ® S-118 (linear alkylbenzene (11.8) sulfonic acid) | 43% |
| STEOL ® OS-370 Plus (linear fatty alcohol ether sulfate) | 7% |
| TRILON ® C (50%) (diethylenetriaminepentaacetate pentasodium) | 17.4% |
| PKFA (palm kernel fatty acids) | 3% |
| ACUSOL ™ 445 (acrylic acid homopolymer) | 6% |
| ACTICIDE ® MBS | 1% |

The base detergent was mixed in several weight proportions (10:90, 20:80, & 30:70 PEG:Detergent) with PEG 1000, PEG 4,000, PEG 6000, and PEG 8000. Masses of each ingredient were weighed into a beaker, covered in aluminum foil, and placed in a 70° C. lab oven to melt the PEG. Once the PEG melted sufficiently to form a flowable detergent/PEG mixture, the beaker was removed from the oven and placed in a water bath at 70° C. where it was mixed using an overhead mixer providing sufficient aeration to achieve a resultant foamed and flowable detergent/PEG mixture in the desired density range. The flowable detergent/PEG mixture was maintained at approximately the same elevated temperature in order to maintain fluidity. Once the formulas were whipped into a flowable foam, samples were taken to measure density. Densities for mixtures of the detergent with PEG 4000 and PEG 8000 are shown below in TABLE 15. At 70° C., formulas with 10% PEG tended to be more viscous than formulas with 20-30% PEG and were harder to aerate, resulting in a denser foam.

TABLE 15

| | Density (g/cm³) | |
|---|---|---|
| PEG % (wt.) | PEG 4000 | PEG 8000 |
| 10% | 0.71 | 0.56 |
| 20% | 0.33 | 0.39 |
| 30% | 0.30 | 0.37 |

Cleaning articles were prepared using PVOH outer layer sheets, and a multilayer “sandwich” structure was made by quickly spreading the PEG-detergent flowable foam on a laundry sheet sample using a spatula. A second (top) laundry sheet was added, and gentle pressure was applied to adhere the flowable foam to top and bottom sheets. The composite sheet was then set aside to cool to allow the flowable foam to solidify into a substantially solid foam structure. Samples were evaluated on processability (e.g., suitable density for the flowable foam), short-term stability (e.g., whether the flowable foam would acceptably solidify to create a stable, solid foam structure), and accelerated aging (e.g., to evaluate ability to retain solid, substantially non-flowing condition of the solid foam structure).

Detergent/PEG 1000 formulas were found to be too fluid at room temperature, resulting in unacceptably leaky composite sheet products. Structures prepared using PEG 4000 or heavier were solid at room temperature. Detergent/PEG 4000 samples were not stable under accelerated aging tests (50° C. lab oven) and liquified quickly resulting in a failed product. PEG 6000 (which has a higher melting point than PEG 4000) fared much better under these conditions (50° C.) but slowly began to migrate into the PVOH (top and bottom) laundry sheets. The PEG 8000 samples remaining mostly unchanged in appearance after a week at 50° C.

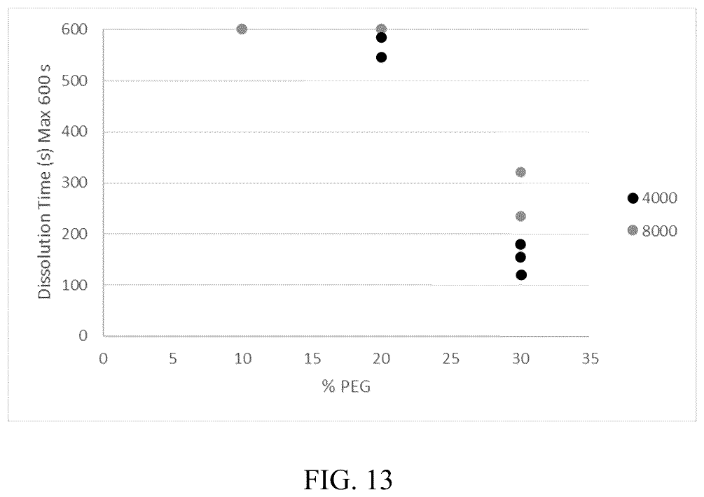

PEG 6000 and PEG 8000 composite sheets were tested for cold water (10° C.) dissolution, wherein a 1 g sample of the composite sheet was placed into a beaker containing 250 mL of DI (deionized) water at 10° C. The sample was stirred (150 rpm) with an overhead stirrer, and the time for the sample to fully dissolve was recorded in triplicate. For samples taking longer than 10 minutes to dissolve, the experiment was stopped. The dissolution times are provided in FIG. 13.

Formulas containing 10% PEG were not completely dissolved in 10 minutes (600 s). The formula with 20% PEG 4000 took between 9-9.5 minutes to dissolve while the PEG 8000 version with the same composition took greater than 10 minutes to fully dissolve. At PEG concentrations of 30%, both PEG 4000 and PEG 8000 dissolved in a time of between 3-5 minutes. These results demonstrate that high levels of the water soluble polymer (e.g., about 30% or greater) can be helpful for dissolution of the solid foam structure. The test was repeated using samples of the PEG/Detergent formulas that were not foamed and present as a solid layer in the composite sheet structure. These samples universally had dissolution time longer than 10 minutes, demonstrating that the porous foam structure was vital to efficient dissolution in water. The testing confirmed that mixtures of detergent and water soluble polymer can form solid water soluble structures useful in multilayer laundry sheets or other unit dose cleaning articles.

### Example 9

Various detergent compositions were prepared to evaluate order of addition of ingredients on the physical properties of the composition and thus usefulness in forming a substantially solid structure that may be used in a cleaning article, and particularly as an intermediate layer positioned between one or more outer sheets. Testing showed that the order of operations in forming the composition and also the alkali source used to neutralize the acidic surfactant ingredient(s) significantly affected the physical state of the composition. In particular, it was found that these factors were relevant to maintain a substantially solid state, such as a powder, dough, or paste while avoiding the formation of semi-solid states, such as a gel.

Compositions suitable for use as an intermediate layer in cleaning articles according to the present disclosure were prepared by forming mixtures of PEG, an alkaline source, surfactants, builders, and detergent adjuvants that were finally neutralized to the desired pH by adding an acidic surfactant (Biosoft® S-118 a dodecylbenzene sulfonic acid-“DBSA”). The test formulations are shown in TABLE 16.

TABLE 16

| | 5671-106-1 | | 5671-106-2 | | 5671-106-3 | |
|---|---|---|---|---|---|---|
| Materials | Wt. % | State | Wt. % | State | Wt. % | State |
| Carbowax ™ PEG 8000 | 30.00 | Powder | 30.00 | Powder | 30.00 | Powder |
| Neodol ® 25-7 (alcohol | 7.91 | Cohesive | 7.91 | Cohesive | 7.91 | Cohesive |
| ethoxylates) | | Powder | | Powder | | Powder |
| Monoethanolamine | 9.89 | Fluid Paste | 0.00 | | 0.00 | |
| Soda Ash (Milled) | 0.00 | | 14.59 | Cohesive | 0.00 | |
| | | | | Powder | | |
| Sodium Bicarbonate | 0.00 | | 0.00 | | 12.39 | Cohesive |
| (Milled) | | | | | | Powder |
| Steol ® OS-370 Plus (linear | 4.90 | Paste | 4.90 | Cohesive | 4.90 | Cohesive |
| fatty alcohol ether sulfate) | | | | Powder | | Powder |
| Trilon ® C (50%) | 6.10 | Paste | 6.10 | Dry Dough | 6.10 | Dry Dough |
| (diethylenetriamine- | | | | | | |
| pentaacetate pentasodium) | | | | | | |
| Palm Kernal Fatty Acid | 2.10 | Paste | 2.10 | Dry Dough | 2.10 | Dry Dough |
| Acusol ™ 445 (acrylic acid | 2.10 | Paste | 2.10 | Dry Dough | 2.10 | Dry Dough |
| homopolymer) | | | | | | |
| Biosoft ® S-118 (dodecyl- | 37.00 | Thin Opaque | 32.30 | Paste | 34.50 | Paste |
| benzene (11.8) sulfonic acid) | | Liquid | | | | |

| | | | |
|---|---|---|---|
| pH (1% dilution) | 9.09 | 9.47 | 6.55 |
| Foam Density | 0.44 | 0.47 | 0.46 |
| Residue After Dissolution | 38.7 ± 6.5% | 35.7 ± 1.5% | 44.7 ± 5.8% |

In TABLE 16, the order of addition of each component of the formulation is from top to bottom, and the physical appearance of each formula after addition of each respective component is listed. Sample 5671-106-1 is essentially the same formulation as in Example 8, but the order of addition of components in forming the composition was changed. With the order of addition shown in TABLE 16, sample 5671-106-1 was in powder form initially and evolved into a thick opaque paste as raw materials were added until addition of the acidic Biosoft® surfactant, at which point the formulation became a thin opaque liquid. The addition of a powdered alkali (soda ash or sodium bicarbonate) for samples 5671-106-2 and 5671-106-3 kept the formulas in a powder or dough-like condition until the addition of the dodecylbenzene sulfonic acid (Biosoft® S-118), where the neutralization exotherm melted the PEG and converted the formula into a viscous paste. Upon final neutralization, the pastes were fluid enough that they could be mechanically aerated to form a foam with a density around 0.4-0.5 g/mL. The foam was layered between two outer sheets (commercially available Arm & Hammer Power Sheets™) and allowed to cool and solidify to form the final, multi-layer laundry article.

In sample 5671-106-1, the heat released by the neutralization reaction between the monoethanolamine and the Biosoft® S-118 was sufficient to fully melt the PEG 8000 resulting in a lower viscosity slurry that was readily mechanically aerated prior to cooling. Addition soda ash in sample 5671-106-2 and sodium bicarbonate in sample 5671-106-3 led to a lower exotherm, and additional heating at around 70° C. was used to sufficiently lower the viscosity to promote facile aeration. The neutralization reaction in sample 5671-106-3 produced CO₂ gas as a byproduct, which contributed to aeration. Added, mechanical aeration was still required. Final pH was measured by dissolving 1 g of the final formula into 100 g of deionized water. The foam density was measured immediately after aeration mixing using a density cup of known volume.

### Example 10

Various detergent compositions were prepared to evaluate effervescence as a factor in dissolution properties of a substantially solid structure that may be used in a cleaning article, and particularly as an intermediate layer positioned between one or more outer sheets. The prepared formulations used a combination of an acid and sodium bicarbonate that, when wetted in wash liquor, will react and form gas bubbles. The bubbles were observed to effervesce and break apart the structure of the solid layer, resulting in faster dissolution. Compositions that were tested in this regard are provided in TABLE 17. It was found that providing the powder ingredients as fine particles promoted homogenous mixing in the paste-like filling composition.

TABLE 17

| | 5671-103-2 | 5671-103-3 | 5671-103-4 | 5671-105-2 |
|---|---|---|---|---|
| | Wt. % | Wt. % | Wt. % | Wt. % |
| Ground Sodium Bicarbonate | 53.74 | 51.73 | 49.19 | 55.00 |
| Ground Citric Acid, Anhydrous | 9.74 | 9.41 | 8.96 | 5.00 |
| Ground Malic Acid | 0.00 | 0.00 | 0.00 | 5.00 |
| Nacconol ® 90 G (dodecyl benzene | 14.61 | 16.93 | 17.90 | 10.00 |
| sulfonic acid, sodium salt) | | | | |
| Stepanol ® ME-DRY (sodium lauryl | 0.00 | 0.00 | 0.00 | 1.00 |
| sulfate powder) | | | | |
| Neodol ® 25-7 (alcohol ethoxylates) | 4.88 | 1.89 | 0.00 | 10.00 |
| Carbowax PEG 600 | 10.17 | 13.34 | 17.70 | 1.00 |
| Glycerin | 1.00 | 1.04 | 0.89 | 8.00 |
| Pluronic ® F-77 (nonionic block | 5.85 | 5.65 | 5.36 | 6.00 |
| copolymer surfactant) | | | | |
| pH (1% dilution) | 7.48 | 7.29 | 7.41 | 7.28 |
| Residue after dissolution | 0% | 0% | 0% | 0% |

It is useful for the intermediate layer compositions used in the presently disclosed, multi-layer laundry articles to be substantially anhydrous to promote stability. The absence of water in the composition, however, slows down the acid base reaction that generates CO₂ gas to facilitate dissolution. While samples 5671-103-2, 5671-103-3, and 5671-103-4 used primarily powdered DBSA (Nacconol® 90 G) as surfactant, sample 5671-105-2 used a 50/50 mixture of powdered Nacconol® 90 G and Neodol® 25-7. Compositions with greater proportions of Neodol® are not stable under elevated temperatures (such as about 50° C. or higher) as it was found that the Neodol migrated from the intermediate layer to the outer layer sheets, giving a greasy texture to the laundry article. This can be remedied through use of components that are effective to immobilize the Neodol® surfactant in the physical structure of the composition. For example, addition of one or more of a solidifying agent a gelling agent, or a powdered absorbing agent can be effective to reduce or eliminate migration of the Neodol® out of the middle layer composition. The particles in the compositions were bound into a paste with several liquid ingredients, such as glycerin and liquid surfactants. In several of these compositions, Neodol® 25-7 was found to add detergency as well function as a binder. Low molecular weight polyethylene glycol (PEG), such as Carbowax 600 (melting point of about 15° C. to about 25° C.) was also found to assist in binding the particles together. Finally Pluronic F-77 (melting point of about 48° C.) was found to bind and stiffen the paste, thus helping to stabilize the intermediate layer against leakage. All of the effervescent formulas completely dissolved, leaving no measurable residue. Testing showed that a variety of organic acids, alone in combination, can be used as an acidity source used to initiate the effervescence effect with the sodium bicarbonate when in contact with water. The tested sample compositions were capable of being processed at about room temperature (such as about 15° C. to about 30° C.). This “cold” processing can enable addition of thermally delicate materials, such as enzymes and fragrances as well as oxygen bleaches, such as sodium percarbonate, to the final product.

### Example 11

Various detergent compositions were prepared to evaluate the use of powdered surfactants in combination with a meltable binder to form a substantially solid structure that may be used in a cleaning article, and particularly as an intermediate layer positioned between one or more outer sheets. PEG was specifically used to bind together powdered surfactants to form an intermediate layer composition. The compositions thus existed in a powdered form until addition of the binder which, when melted, converted the composition into a paste. Mixing was performed at elevated temperatures (such as about 50° C. or higher) to maintain the binder in a liquid state and prevent the paste from solidifying prematurely. The hot paste was layered between two outer sheets (commercially available Arm & Hammer Power Sheets™) to form a sandwich structure once the filling cooled and hardened. The tested compositions are shown in TABLE 18.

TABLE 18

| | 5671-99-1 | 5671-105-1 | 5671-107-1 |
|---|---|---|---|
| | Wt. % | Wt. % | Wt. % |
| Nacconol ® 90 G (dodecyl benzene | 30.65 | 49.93 | 50.00 |
| sulfonic acid, sodium salt) | | | |
| Bioterge ® AS-90 (Anionic C14-16 | 20.13 | 0.00 | 0.00 |
| olefin sulfonate) | | | |
| Stepanol ® ME-DRY (sodium lauryl | 10.10 | 0.00 | 0.00 |
| sulfate powder) | | | |
| Acusol ™ 445 (acrylic acid | 0.00 | 2.45 | 0.00 |
| homopolymer) | | | |
| Acusol ™ 445ND (acrylic acid | 0.00 | 0.00 | 1.00 |
| detergent homopolymer) | | | |
| Trilon ® C (50%) | 0.00 | 5.92 | 0.00 |
| (diethylenetriamine- | | | |
| pentaacetate pentasodium) | | | |
| Trilon ® M (ground) | 0.00 | 0.00 | 3.00 |
| Neodol ® 25-7 (alcohol ethoxylates) | 0.00 | 0.00 | 10.00 |
| Glycerin | 0.00 | 3.15 | 0.00 |
| Sodium Starch Glycolate | 0.00 | 0.00 | 10.00 |
| Carbowax PEG 8000 | 39.12 | 38.55 | 26.00 |
| pH (1% dilution) | 5.79 | 8.07 | 10.33 |
| Residue after dissolution | 44.3 ± | 27.7 ± | 33.0 ± |
| | 2.5% | 4.2% | 4.6% |

Sample 5671-99-1 was a simple mixture of three powdered surfactants mixed together and then introduced to liquid PEG 8000 to form a slurry. The slurry was rapidly spread over a PVOH laundry sheet and topped with a second PVOH laundry sheet to form a water soluble, multi-layer sandwich structure. Sample 5671-105-1 showed that liquid ingredients (Trilon® C, Acusol® 445, and glycerin) were capable of successfully being added to the detergent powder. Sample 5671-107-1 incorporated powdered and liquid surfactants as well as a disintegrant (sodium starch glycolate) to improve disintegration and dissolution of the fill layer when exposed to water.

### Example 12

Various detergent compositions were prepared to evaluate the use of soluble and insoluble particle fillers to stiffen a surfactant mixture to make is less flowable and thus suitable for use in a cleaning article, and particularly as an intermediate layer positioned between one or more outer sheets. Particles were found to provide performance benefits as well as increase 10 paste viscosity and were effective to minimize leakage of the intermediate layer composition during storage and handling. The tested samples are shown in TABLE 19.

TABLE 19

| | 5671-103-1 | 5770-17-2 | 5770-17-3 | 5770-17-4 | 5770-17-5 |
|---|---|---|---|---|---|
| | Wt. % | Wt. % | Wt. % | Wt. % | Wt. % |
| Sodium Bicarbonate | 64.73 | 9.09 | 0.00 | 0.00 | 0.00 |
| Nacconol ® 90 G (dodecyl benzene | 9.95 | 0.00 | 0.00 | 0.00 | 0.00 |
| sulfonic acid, sodium salt) | | | | | |
| Neodol ® 25-7 (alcohol | 9.97 | 13.39 | 13.39 | 13.39 | 13.39 |
| ethoxylates) | | | | | |
| PEG 600 | 8.00 | 0.00 | 0.00 | 0.00 | 0.00 |
| Glycerin | 1.04 | 0.00 | 0.00 | 0.00 | 0.00 |
| Pluronic ® F-77 (nonionic block | 6.31 | 0.00 | 0.00 | 0.00 | 0.00 |
| copolymer surfactant) | | | | | |
| Monoethanolamine | 0.00 | 13.39 | 13.39 | 13.39 | 13.39 |
| Biosoft ® S-118 (dodecyl-benzene | 0.00 | 51.71 | 51.71 | 51.71 | 51.71 |
| (11.8) sulfonic acid) | | | | | |
| Steol ® OS-370 Plus (linear fatty | 0.00 | 8.42 | 8.42 | 8.42 | 8.42 |
| alcohol ether sulfate) | | | | | |
| PKFA | 0.00 | 3.61 | 3.61 | 3.61 | 3.61 |
| Aerosil ® R 816 (fumed silica | 0.00 | 0.00 | 9.09 | 0.00 | 0.00 |
| after-treated with hexadecylsilane) | | | | | |
| Aerosil ® 150 (fumed silica with | 0.00 | 0.00 | 0.00 | 9.09 | 0.00 |
| specific surface area of 150 m²/g) | | | | | |
| Aerosil ® 300 (fumed silica with | 0.00 | 0.00 | 0.00 | 0.00 | 9.09 |
| specific surface area of 300 m²/g) | | | | | |
| pH (1% dilution) | 8.56 | 8.90 | 8.98 | 9.01 | 8.99 |
| Residue after dissolution | 2.7 ± 2.5% | 60.3 ± | 70.6 ± | 58.3 ± | 63.2 ± |
| | | 2.7% | 2.1% | 2.7% | 4.0% |

Sample 5671-103-1 was formed with a high level of water soluble sodium bicarbonate to provide greater alkalinity in wash while also providing a high level of stiffness to the detergent paste. Sample 5770-17-2 was formed with a significantly lower level of sodium bicarbonate and thus had an enhanced surfactant concentration relative to sample 5671-103-1. It was found that stiffening particles do not necessarily need to be water soluble so long as they are water dispersible in wash liquor and result in minimal to no deposition remaining on fabric after washing. Samples 5770-17-3, 5770-17-4, and 5770-17-5 were prepared using fumed amorphous silica particles (Aerosil) to increase the stiffness of the composition. Sample 5671-103-1, which included a high concentration of soluble particles, demonstrated the best degree of dissolution as shown by the minimal residue remaining after dissolution relative to the remaining four samples. Other particulate materials (such as starches and other water soluble salts) can likewise provide the same benefits as shown particularly with sample 5671-103-1. These compositions did not require elevated temperatures to process and thus are suitable for use with heat sensitive raw materials.

Dissolution testing for each of foregoing Examples 9-12 was evaluate gravimetrically under harsh conditions of cold water and relatively short dissolution test time. In each case, a laundry article was made using the sample compositions prepared according to Examples 9-12 as an intermediate layer in a sandwich configuration between two outer sheets (commercially available Arm & Hammer Power Sheets™). A 1 g sample of each laundry article was placed in 1 L of stirred, cold deionized water (10.0° C.±0.5° C., 49.1° F.-50.9ºF). Water was stirred at 250 rpm using a 70 mm stir-bar in a 2 L beaker. The sample was allowed to dissolve for 5 minutes, and the solution was filtered through a stainless-steel mesh filter on a Buchner funnel vacuum filtration system. The metal mesh (with any undissolved residue) was allowed to dry, and the mass of the residue was determined. The result was expressed as a percent of the original sample mass. It was noted that the outer layer sheets when tested under these conditions typically had a residue of 0%, meaning most of the residue from sandwich samples was related to undissolved intermediate layer composition.

### Example 13

Wash testing was carried out in a Terg-o-tometer lab scale washing machine to test wash efficacy of samples from Examples 9-12. Machine parameters were as follows: load size of 1 L; wash temperature of 86° C.±0.5° F.; wash duration of 10 minutes; rinse temperature ambient; rinse duration of 5 minutes; water hardness of 120 ppm CaCO₃ equivalent; and impeller speed of 95-100 rpm. Stains used were a limited selection from ASTM test method D4265-21 and were as follows: grass stain on cotton fabric; blueberry stain on cotton fabric; dirty motor oil stain on cotton fabric; makeup on polycotton fabric; and dust/sebum on polycotton fabric. Two swatches of each stain were included in a single detergent treatment, and each detergent treatment was run in duplicate resulting in a sample size of 4 swatches of each stain. Color values of each swatch were measured before and after washing using an imaging colorimeter (MACH5+, available from ColourConsult BV, Netherlands). The stain removal index (SRI) was calculated as per section 10 of ASTM D4265-21. SRI values were averaged and compared to a control detergent using the least significant difference (LSD) statistical method. Dosing was done assuming an 11 gallon (42 L) top load HE machine wash water volume scaled to the 1 L volumes used in the Terg-o-tometer. Arm & Hammer Clean Burst (“AHCB”) liquid laundry detergent was used as the control wash treatment. Formulations were allowed to dissolve completely prior to adding stain swatches and starting the wash procedure. The AHCB was dosed at 0.73 g/L. For each test sample, the outer sheet layers were present at a dose of 0.1 g/L, and the intermediate layer compositions were present at a dose of 0.24 g/L.

Washing performance data on select samples from Examples 9-12 is shown in TABLES 20-22. The % SRI scores are the average of the four samples tested. The summed % SRI (total of all 5 stains) is listed at the bottom and gives a rough indication of total cleaning efficacy for all stain/fabric types.

TABLE 20

| | | Wash Test Number | | | |
|---|---|---|---|---|---|
| | | A | B | C | D |
| | | Treatment | | | |
| | | AHCB | 5671-75-1 | 5671-103-4 | 5671-105-2 |
| Stain | Fabric | A-% SR | B-% SR | C-% SR | D-% SR |
| Grass | Cotton | 24.6 | 23.7 | 23.6 | 25.5 |
| Blueberry | Cotton | 66.4 | 64.6 | 62.6 | 63.8 |
| Dirty | Cotton | 11.0 | 11.3 | 6.3 | 10.0 |
| Motor Oil | | | | | |
| Makeup | Polycotton | 64.8 | 81.1 | 78.5 | 75.9 |
| Dust/Sebum | Polycotton | 54.8 | 43.1 | 43.8 | 48.3 |

| | | | | |
|---|---|---|---|---|
| Total SRI | 221.6 | 223.7 | 214.7 | 223.5 |

TABLE 21

| | | Wash Test Number | | | |
|---|---|---|---|---|---|
| | | E | F | G | H |
| | | Treatment | | | |
| | | 5671- | 5671- | 5770- | 5770- |
| | | 105-1 | 103-1 | 17-2 | 17-4 |
| Stain | Fabric | E-% SR | F-% SR | G-% SR | H-% SR |
| Grass | Cotton | 28.3 | 25.0 | 17.3 | 23.9 |
| Blueberry | Cotton | 65.3 | 65.6 | 62.1 | 61.8 |
| Dirty | Cotton | 7.7 | 9.9 | 14.0 | 13.0 |
| Motor Oil | | | | | |
| Makeup | Polycotton | 80.5 | 75.0 | 79.4 | 82.4 |
| Dust/ | Polycotton | 32.1 | 48.8 | 45.9 | 43.8 |
| Sebum | | | | | |

| | | | | |
|---|---|---|---|---|
| Total SRI | 213.9 | 224.3 | 218.7 | 224.9 |

TABLE 22

| | | Wash Test Number | | | |
|---|---|---|---|---|---|
| | | I | J | K | |
| | | Treatment | | | LSD for |
| | | 5671- | 5671- | 5671- | all of |
| | | 106-1 | 106-2 | 106-3 | Samples |
| Stain | Fabric | I-% SR | J-% SR | K-% SR | A-K |
| Grass | Cotton | 23.3 | 20.2 | 21.8 | 1.2 |
| Blueberry | Cotton | 62.0 | 69.2 | 62.3 | 1.7 |
| Dirty | Cotton | 10.8 | 9.6 | 11.6 | 1.5 |
| Motor Oil | | | | | |
| Makeup | Polycotton | 82.5 | 82.2 | 80.5 | 1.0 |
| Dust/ | Polycotton | 42.6 | 51.0 | 40.7 | 1.2 |
| Sebum | | | | | |

| | | | |
|---|---|---|---|
| Total SRI | 221.1 | 232.1 | 216.9 |

The total % SRI score ranged from 213.9 to 232.1 with the control being 221.6. These were all extremely close with the average score being 99.9±2.4% of the control score. More nuance in the data is observed for the statistical differences in treatments at a stain level.

The terms “about”, “substantially”, and “generally” as used herein can indicate that certain recited values or conditions are intended to be read as encompassing the expressly recited value or condition and also values that are relatively close thereto or conditions that are recognized as being relatively close thereto. For example, unless otherwise indicated herein, a value of “about” a certain number or “substantially” or “generally” a certain value or result can indicate the specific number, value, or result as well as numbers, values, or results that vary therefrom (+ or −) 2% or less, or 1% or less. Similarly, unless otherwise indicated herein, a condition that substantially exists can indicate the condition is met exactly as described or claimed or is within typical manufacturing tolerances or would appear to meet the required condition upon casual observation even if not perfectly meeting the required condition. In some embodiments, the values or conditions may be defined as being express and, as such, the term “about” or “substantially” (and thus the noted variances) may be excluded from the express value. Where a plurality of possible lower end values and a plurality of possible upper end values are provided for a particular parameter, it is understood that all possible combinations of values inclusive of any of the lower end values and any of the upper end values are encompassed for describing the parameter.

Many modifications and other embodiments of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A cleaning article comprising:
a first outer layer that is porous and comprises a water soluble polymer;
a second outer layer that is porous and comprises a water soluble polymer; and
an intermediate layer arranged between the first outer layer and the second outer layer, the intermediate layer comprising at least a first segment and a second segment, the first segment being formed of a first composition having at least one cleaning component and the second segment being formed of a second composition having at least one cleaning component, the second composition being different from the first cleaning composition, the at least a first segment and a second segment being arranged one or both of longitudinally and laterally across the cleaning article.

2. The cleaning article of claim 1, wherein one or both of the first outer layer and the second outer layer comprises a cleaning component.

3. The cleaning article of claim 1, wherein one or both of the first outer layer and the second outer layer is configured as a solid foam sheet.

4. The cleaning article of claim 1, wherein one or both of the first outer layer and the second outer layer is configured as fabric.

5. The cleaning article of claim 1, wherein the first outer layer and the second outer layer each are configured as a sheet with a porosity, measured as pore void volume divided by a total sheet volume, the porosity being about 10% to about 90%.

6. The cleaning article of claim 1, wherein at least one of the first composition and the second composition is configured as a foam comprising a water soluble polymer having a melting point in the range of about 40° C. to about 80° C. mixed with the at least one cleaning component.

7. The cleaning article of claim 6, wherein the water soluble polymer is a polyethylene glycol (PEG) polymer.

8. The cleaning article of claim 7, wherein the PEG polymer has a molecular weight of about 8,000 Da to about 20,000 Da.

9. The cleaning article of claim 6, wherein the water soluble polymer comprises about 10% to about 50% by weight of the foam structure.

10. The cleaning article of claim 1, wherein at least one of the first cleaning composition and the second cleaning composition is configured as a semi-solid.

11. The cleaning article of claim 10, wherein the semi-solid has a complex modulus (G*) at ambient temperature of no less than 5,000 Pa.

12. The cleaning article of claim 10, wherein the semi-solid is a paste.

13. The cleaning article of claim 10, wherein the semi-solid comprises about 10% by weight or greater of one or both of water soluble solids and water insoluble solids.

14. The cleaning article of claim 13, wherein the semi-solid comprises water soluble solids in an amount of about 30% to about 80% by weight based on the total weight of the cleaning composition.

15. The cleaning article of claim 10, wherein the semi-solid comprises an alkali metal salt.

16. The cleaning article of claim 10, wherein the semi-solid is anhydrous.

17. The cleaning article of claim 16 wherein the semi-solid comprises at least one base and at least one acid effective to react and form carbon dioxide gas when in contact with water.

18. The cleaning article of claim 1, wherein the cleaning article is substantially completely water soluble at a temperature of about 15° C. to about 30° C. in a time of about 0.5 minutes to about 10 minutes.

19. The cleaning article of claim 1, wherein the at least one cleaning component is selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).

20. The cleaning article of claim 1, wherein the first composition and the second composition individually comprise one of a cleaning composition, an odor elimination composition, a softening composition, a bleaching composition, an enzymatic composition, and a booster composition.

21. The cleaning article of claim 1, wherein the first composition has a first color and the second composition has a second color that is visually distinct from the first color.

22. The cleaning article of claim 21, wherein the first color of the first composition corresponds to a first cleaning function and the second color of the second composition corresponds to a second cleaning function that is different from the first cleaning function.

23. The cleaning article of claim 21, wherein the at least a first segment and a second segment are arranged as a colored pattern that is visible through one or both of the first outer layer and the second outer layer.

24. The cleaning article of claim 23, wherein the colored pattern is an alternating pattern of one or both of linear and curved strips.

25. The cleaning article of claim 23, wherein one or both of the first outer layer and the second outer layer has a transparency of about 5% to about 50%.

26. The cleaning article of claim 23, wherein a brightness of each of the first color and the second color is greater in a cross-sectional view of the cleaning article than when the intermediate layer is viewed through one or both of the first outer layer and the second outer layer.

27. The cleaning article of claim 21, wherein at least one of the first color and the second color is defined by one of the following:
a blue color defined by L*a*b* values of about 64, about −14, and about −20, respectively;
a green color defined by L*a*b* values of about 75, about −10, and about 8, respectively,
a purple color defined by L*a*b* values of about 75, about 5, and about −7, respectively.

28. The cleaning article of claim 21, wherein the first color has a first set of L*a*b* values when measured at an edge of the cleaning article where the intermediate layer is unobstructed by the first outer layer or the second outer layer and has a second, different set of L*a*b* values when measured through one of the first outer layer and the second outer layer.

29. The cleaning article of claim 28, wherein the L* value of the first color is greater when measured through one of the first outer layer and the second outer layer.

30. The cleaning article of claim 28, wherein one or both of the a* value and the b* value is less when measured through one of the first outer layer and the second outer layer.

31. The cleaning article of claim 1, wherein the cleaning article has a length measured along a longitudinal axis, a width measured across a lateral axis, and a thickness measured transverse to the longitudinal axis and the lateral axis, and wherein one of the following applies:
the cleaning article is configured with a ratio of length to width (L:W) of about 1:1 to about 10:1;
the cleaning article is configured with a ratio of length to thickness (L:T) of about 10:1 to about 200:1;
the first outer layer, the second outer layer, and the intermediate layer each have individual thicknesses, and a ratio of the individual thickness of either of the first outer layer or the second outer layer to the individual thickness of the intermediate layer is about 0.05:1 to about 2:1.

32. The cleaning article of claim 1, wherein the first outer layer has a first outer layer face with a first face area, the second outer layer has a second outer layer face with a second face area, and a sum of the first face area and the second face area is a total face surface area of the cleaning article;
wherein the intermediate layer defines an edge along one or more sides of the cleaning article where the intermediate layer is not covered by the first outer layer or the second outer layer, the edge having a total edge surface area; and
wherein the cleaning article is configured with an Edge to Face Area Ratio (EFAR) defined as a ratio of the total edge surface area to the total face surface area, of less than 0.5.

33. The cleaning article of claim 32, wherein the EFAR is about 0.01 to about 0.5.

34. A method of preparing a cleaning article, the method comprising:
combining a first composition having at least one cleaning component and a second composition having at least one cleaning component with a first outer layer and a second outer layer to form an intermediate layer between the first outer layer and the second outer layer;
wherein the first composition defines a first segment of the intermediate layer, and the second composition defines a second segment of the intermediate layer; and
wherein the combining is carried out so that the first segment and the second segment are arranged one or both of longitudinally and laterally across the cleaning article between the first outer layer and the second outer layer.

35. A cleaning article prepared according to the method of claim 34.

36. The cleaning article of claim 35, wherein the first outer layer and the second outer layer are each porous and comprise a water soluble polymer.

37. The cleaning article of claim 35, wherein the cleaning article is substantially completely water soluble at a temperature of about 15° C. to about 30° C. in a time of about 0.5 minutes to about 10 minutes.

38. The cleaning article of claim 35, wherein the at least one cleaning component is selected from the group consisting of surfactant(s), enzyme(s), stabilizer(s), dye(s), optical brightener(s), anti-redeposition agent(s), fluorescent whitening agent(s), fragrance(s), chelating agent(s), foam regulator(s), corrosion inhibitor(s), dye transfer inhibitor(s), softener(s), fragrance(s), pH control & buffer(s), antioxidant(s), viscosity builder(s), formulation aid(s), bittering agent(s), thickener(s), antifoaming agent(s), pH adjustor(s), bleach(es), fabric softener(s), pearl luster agent(s), preservative(s), and laundry booster(s).
